(19) United States
(12) Patent Application Publication
(10) Pub. No.: US 2005/0021402 A1
(43) Pub. Date: Jan. 27, 2005

(54) Method and apparatus for providing internet based marketing channels

(76) Inventor: Stephen M. Strasser, Naples, NY (US)

Correspondence Address: HISCOCK & BARCLAY, LLP, 2000 HSBC PLAZA, ROCHESTER, NY, 14604-2404, US

(21) Appl. No.: 10/860,986

(22) Filed: Jun. 4, 2004

Related U.S. Application Data
(60) Provisional application No. 60/475,587, filed on Jun. 4, 2003.

(51) Int. Cl. G06F 17/60

(52) U.S. Cl. 705/14; 705/10; 705/27

(57) ABSTRACT

This invention is an interactive internet based system that will allow customers to view, and participate in multiple incentive programs via said single interactive internet based system. The customers will be able to choose for themselves from a list of qualifying incentive programs. Additionally, the customers will be ready to track and control their participation, including the redemption of the aforementioned incentives. Furthermore, this system allows vendors to create, manage, and track their incentive programs utilizing the same interactive internet based system. Vendors will be able to design, submit, and manage their own customer incentive programs and business activity down to the customer level, wherein the data is updated real time or daily.

### CROSS-REFERENCE TO RELATED APPLICATIONS

This application claims priority from U.S. Provisional Application Ser. No. 60/475,587, filed Jun. 4, 2003.

### TECHNICAL FIELD

The present invention relates to a method and apparatus for providing a marketing system; more particularly, to an internet based method and apparatus for providing a marketing system for tracking and managing sales incentive programs; and most particularly, to an internet based method and apparatus for providing a sales incentive program in the foodservice industry.

### BACKGROUND

Electronic Sourcing Systems and purchasing systems that manage and process requisitions are known. One such system is the Electronic Sourcing System described in U.S. Pat. No. 6,505,172. The invention provides an electronic sourcing method and system that provides a user with the capability of searching a database containing data (including product/vendor identification, and other product information) relating to items available from at least two vendor product catalogs, and the capability of transferring the product information for desired catalog items obtained as a result of the search to a requisition/purchasing system for use in generating a requisition including entries for the desired catalog items. Additionally, the invention provides an electronic sourcing system that provides a means for bi-directionally transferring information between a requisition/purchasing system that may use the results of a search of such product information, and a means for searching large volumes of product information such as would be included in a vendor product catalog. Furthermore, the system is capable of creating an order list including desired catalog items located as the result of such a database search, and transferring that order list to a requisition/purchasing system for generating a requisition including entries for the desired catalog items. The system includes a computer that maintains a catalog database of data including product information relating to catalog items available from vendor product catalogs, and a means for generating a requisition including at least one requisitioned item. Information at least partially identifying an item desired to be requisitioned is entered by a user, and utilized by a means for searching the database for catalog items matching that information and for selecting at least one catalog item located as a result of the search. Text describing the catalog items, and images of the items, may be viewed. Data identifying selected catalog items are communicated to the requisition building means, which generates a requisition including entries for items corresponding to the selected catalog items. Additionally, the invention includes a means for checking the availability in one or more inventory locations of the corresponding desired catalog items, and for generating one or more purchase orders for desired items from inventory locations stocking the items.

Additionally, methods and apparatus for disseminating product information via the internet are known. One such method and apparatus for disseminating product information via the internet is described in U.S. Pat. No. 6,418,441. The invention provides a method and apparatus for delivering information about products and manufacturers via the Internet using all or part of the universal product codes which designate these products and manufacturers as Internet access keys. The product information is stored in Internet servers; preferably in XML format, by the manufacturers who both produce the products and control the content of the stored product information.

This system further allows Internet shoppers and others who desire product information to view web pages via the Internet from on-line merchants and other sources. These web pages may contain one or more links to product information, and each such link contains a reference which designates a particular product by its corresponding universal product code. When the web browser operated by the shopper activates such a link, a request, message containing at least a portion of the universal product code is sent via the Internet to a cross-referencing database, preferably maintained by the Internet Domain Name Service, which returns the Internet address of the particular manufacturer's server which then makes the desired product information available. Additionally, the invention provides product information to web customers who visit web sites operated on behalf of retail stores which use universal product codes both for bar code checkout and to identify specific products in a computerized inventory control system. The retailer's inventory control systems need not store detailed product information since, by means of the invention, the universal product codes of items being offered for sale can be used to access product information directly from the manufacturer's servers.

Generally, a number of industries, and the foodservice industry in particular, provide incentive programs for the customers that use their products. The system awards the customers with points in return for purchasing the designated items. The customers are then allowed to redeem these incentive points for rewards. In furtherance of this system, it is essential that these incentive programs to be communicated to customers and distributors alike, thereby assuring the greatest participation. Furthermore, it is essential that manufacturers and distributors have the ability to track and manage their incentive programs.

Presently, none of the known systems allow a customer or user to participate in multiple incentive programs via a single interactive internet based system. Furthermore, none of the known systems allow vendors to create, manage, and track their incentive programs utilizing the same interactive internet based system. Still furthermore, none of the existing systems currently allow distributors to approve, monitor, and manage the programs and point banks using the aforementioned interactive internet based system.

It would be desirable to provide a system that would allow a customer or user to participate in multiple incentive programs via a single interactive internet based system.

It would further be desirable to provide a system that would allow vendors to create, manage, and track their incentive programs utilizing the same interactive internet based system.

It would still further be desirable to provide a system that would allow distributors to approve, monitor, and manage the programs and point banks using the aforementioned interactive internet based system.

### SUMMARY OF THE INVENTION

This invention is an interactive internet based system that will allow customers to view, and participate in multiple incentive programs via said single interactive internet based system. The customers will be able to choose for themselves from a list of qualifying incentive programs. Additionally, the customers will be ready to track and control their participation, including the redemption of the aforementioned incentives.

This system allows vendors to create, manage, and track their incentive programs utilizing the same interactive internet based system. Vendors will be able to design, submit, and manage their own customer incentive programs and business activity down to the customer level, wherein the data is updated real time or daily.

Furthermore, this invention allows distributors to approve, monitor, and manage the programs and point banks using the aforementioned interactive internet based system. The distributors will be able to facilitate and efficiently manage the programs and transactions thereby maximizing the returns for all parties.

### BRIEF DESCRIPTION OF THE DRAWINGS

The invention as well as its features and advantages will become more apparent from the following description of a preferred embodiment of the invention and the accompanying drawings in which like numerals represent like parts.

FIG. 1 is a representation of the user login window;

FIGS. 2a-2f are representations of the customer selectable pages;

FIGS. 3a-3g are representations of the Distributor or Administrator selectable pages;

FIGS. 4a-4j are representations of the Distributor Sales Representative (DSR) selectable pages;

FIGS. 5a-5e are representations of manufacturer selectable pages; and

FIGS. 6a-6f are representations of broker selectable pages.

### DETAILED DESCRIPTION OF THE INVENTION

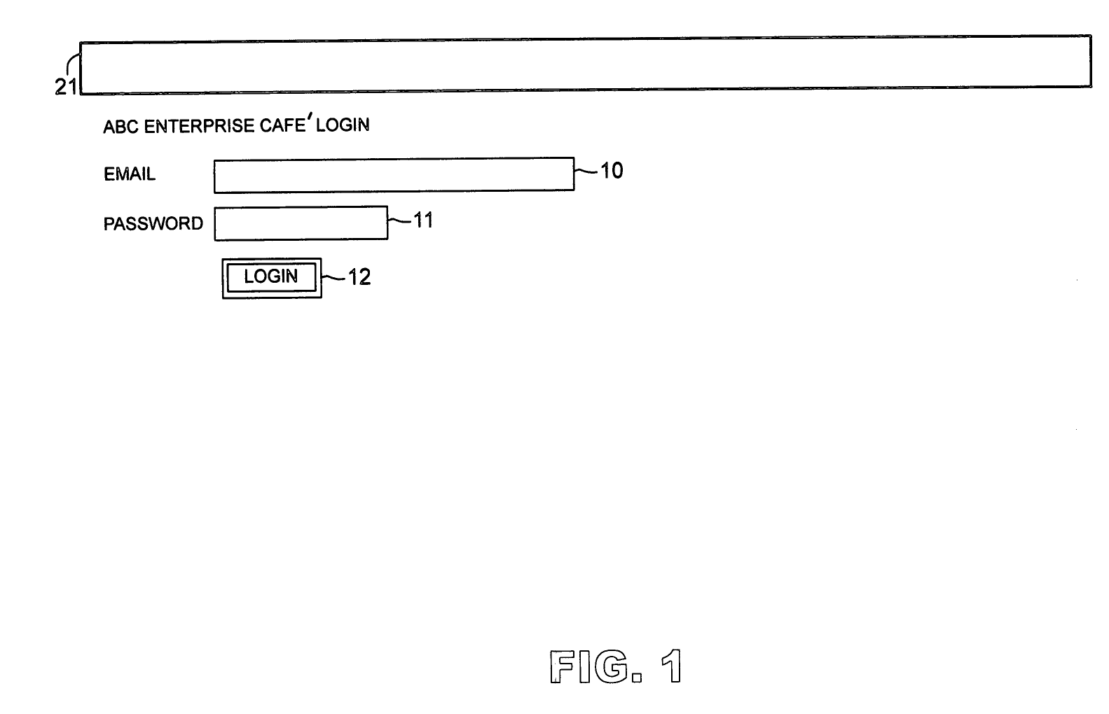

Referring now to the figures, particularly FIG. 1, a page displaying the general log-in interface is shown. The user may request entry to the application by submitting an identifier that identifies the user, such as, for example, an e-mail address 10 and password 11, and subsequently selecting the login icon 12. Based on the level of access granted to the user, they will gain admittance to their authorized area (including, but not limited to the customer interface, the distributor interface, or the vender interface).

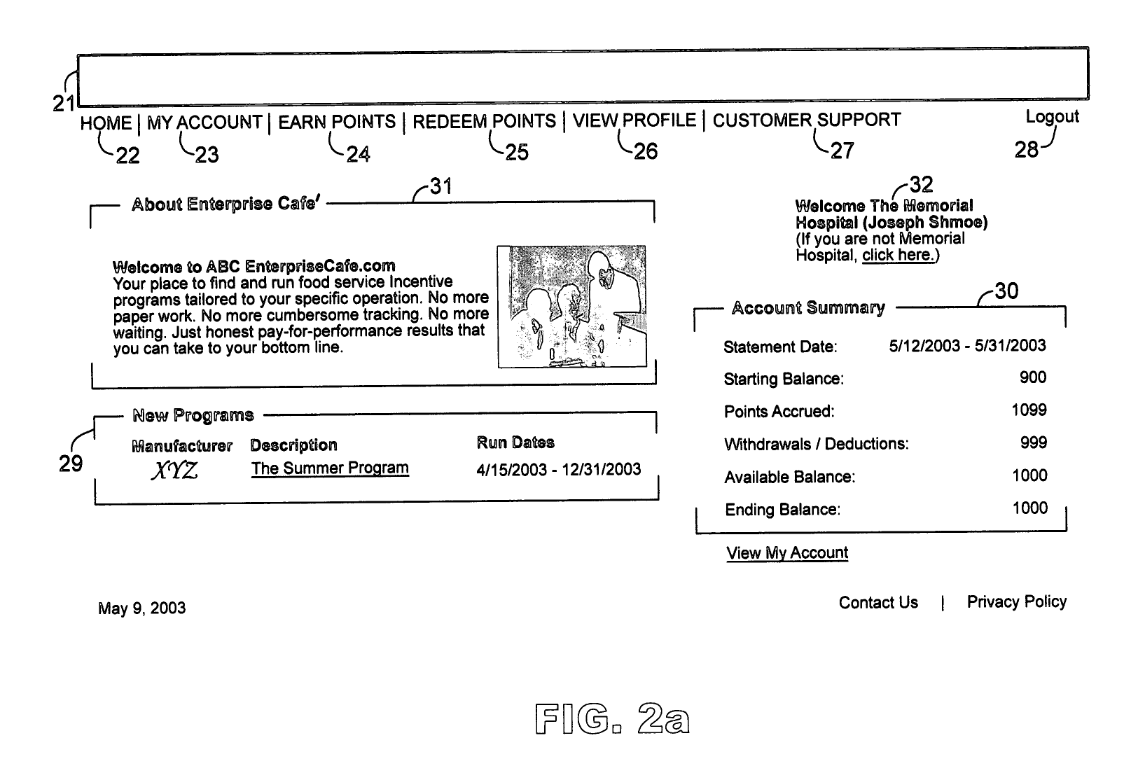

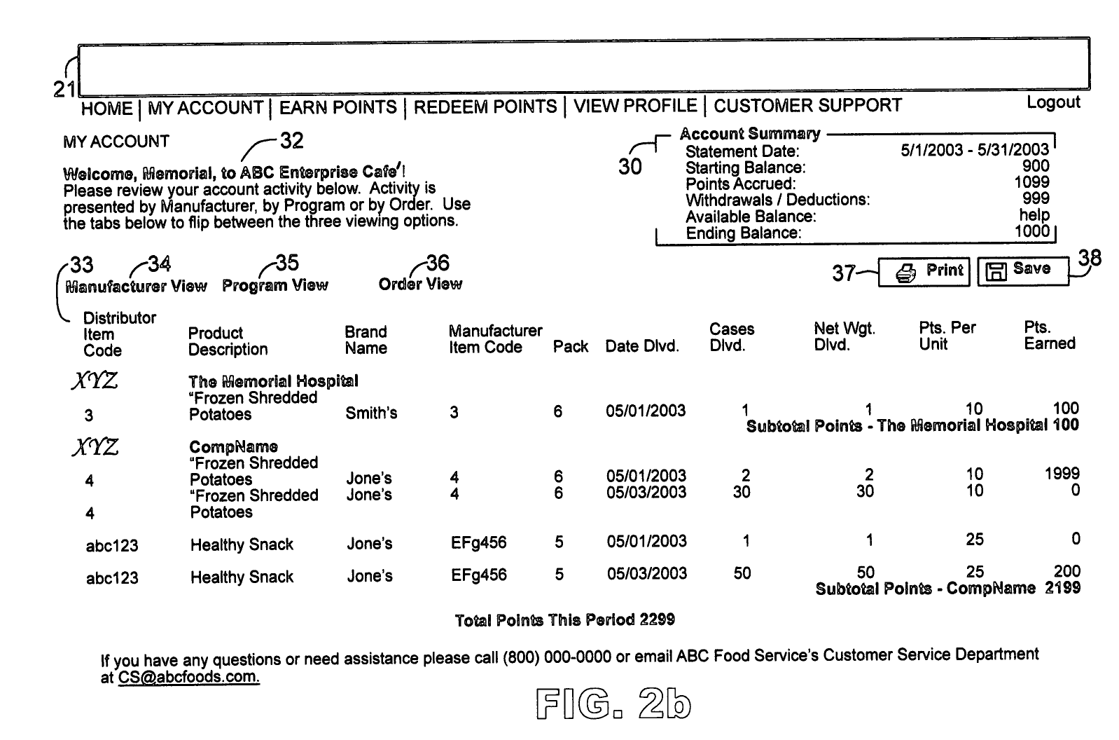

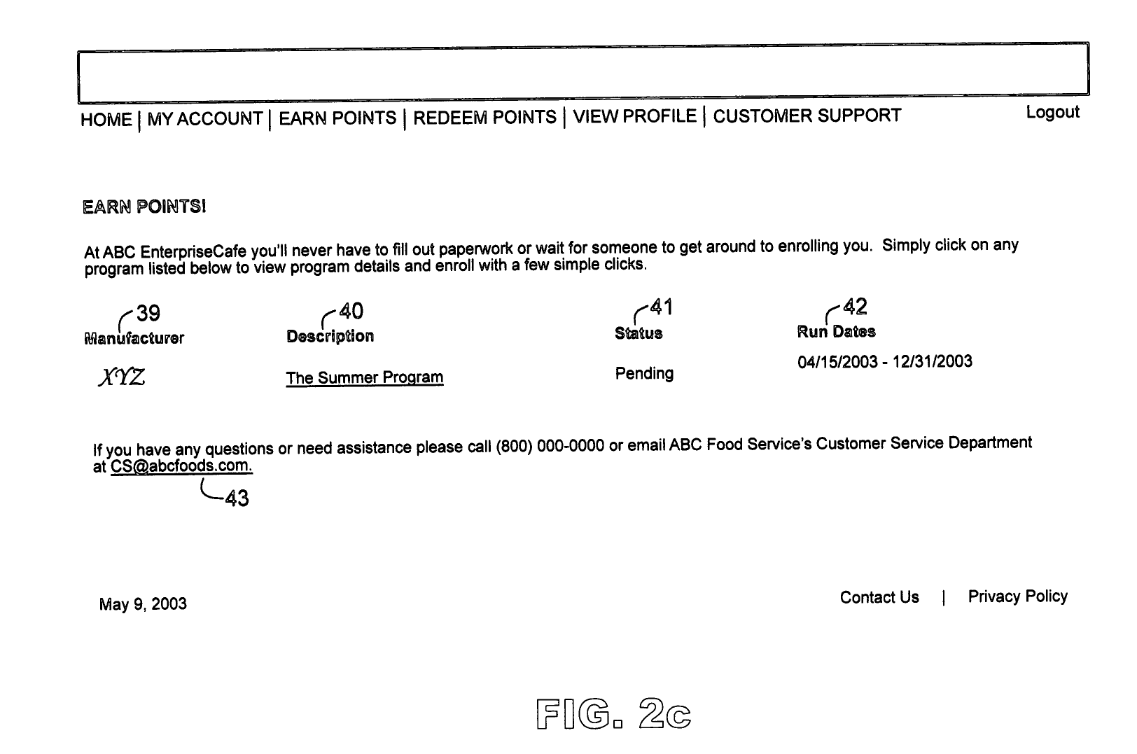

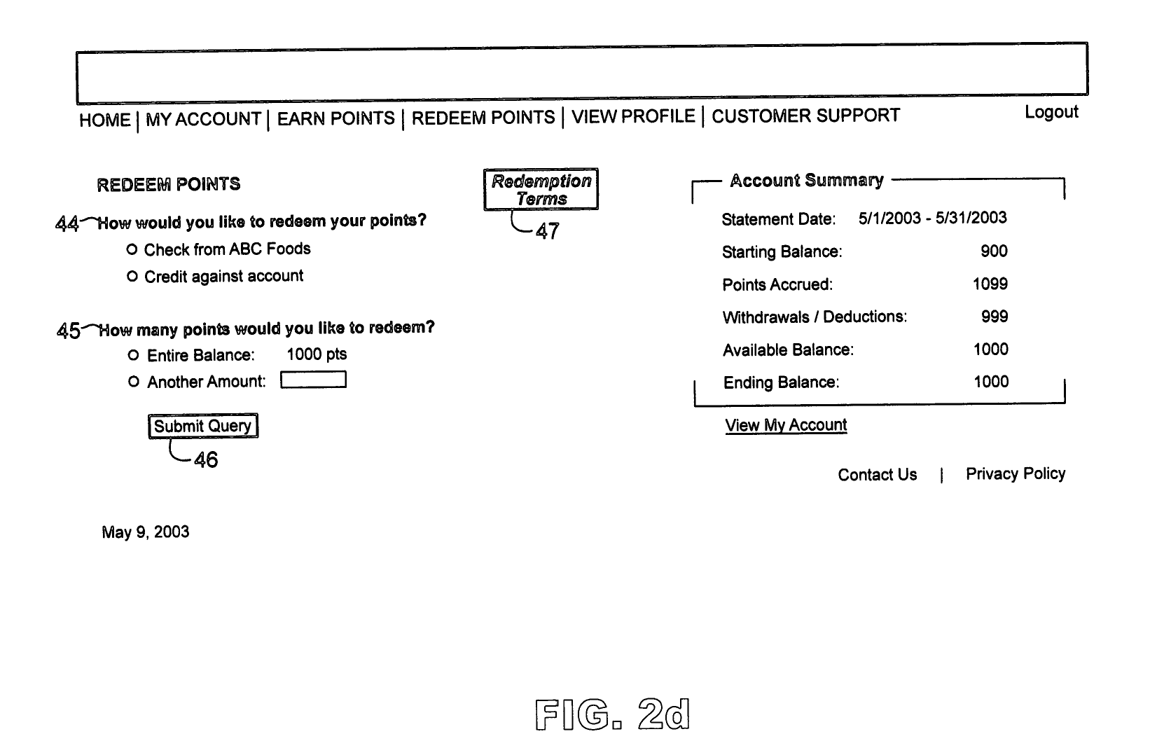

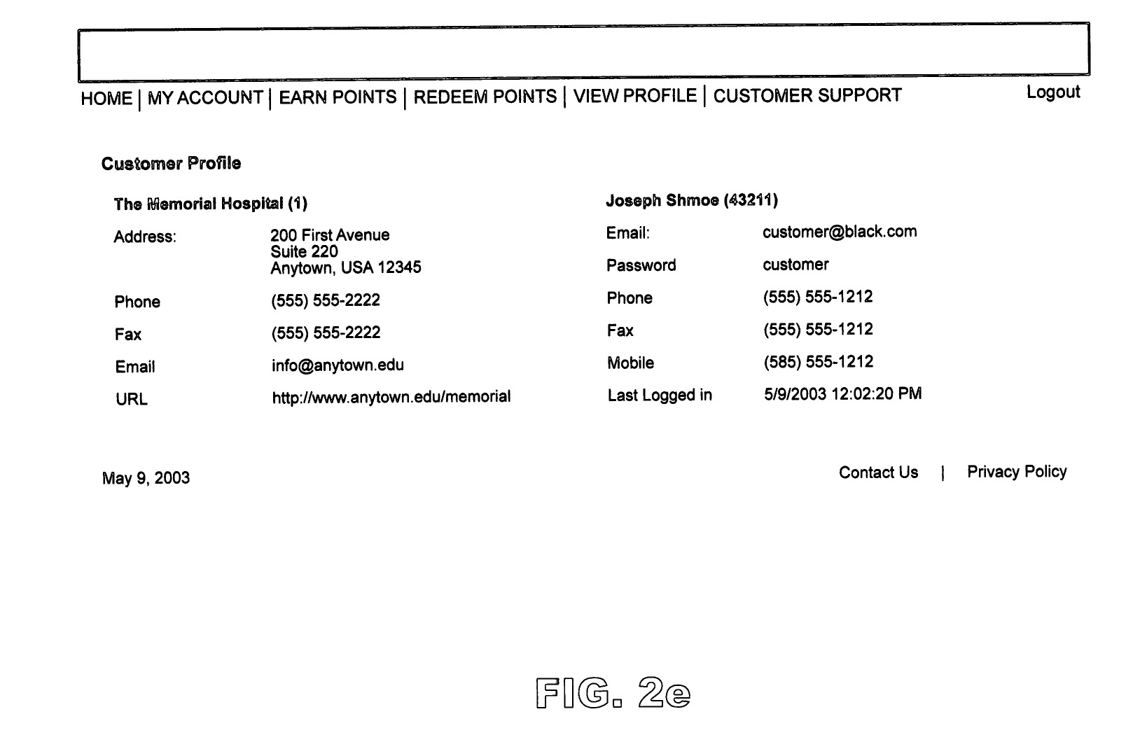

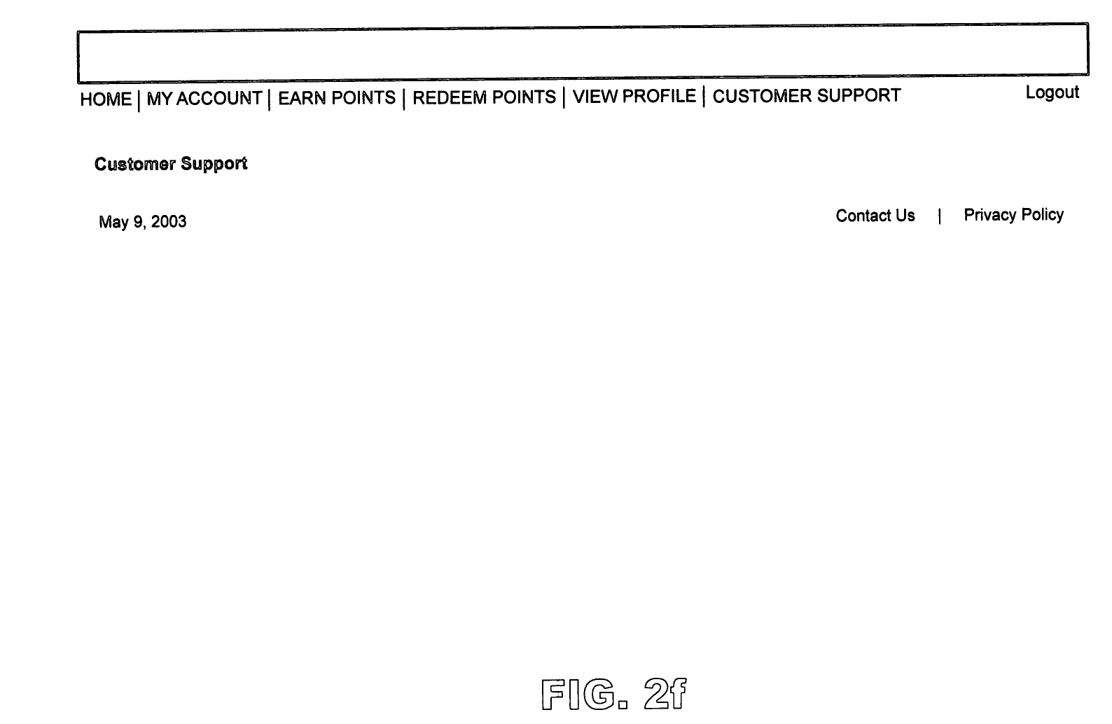

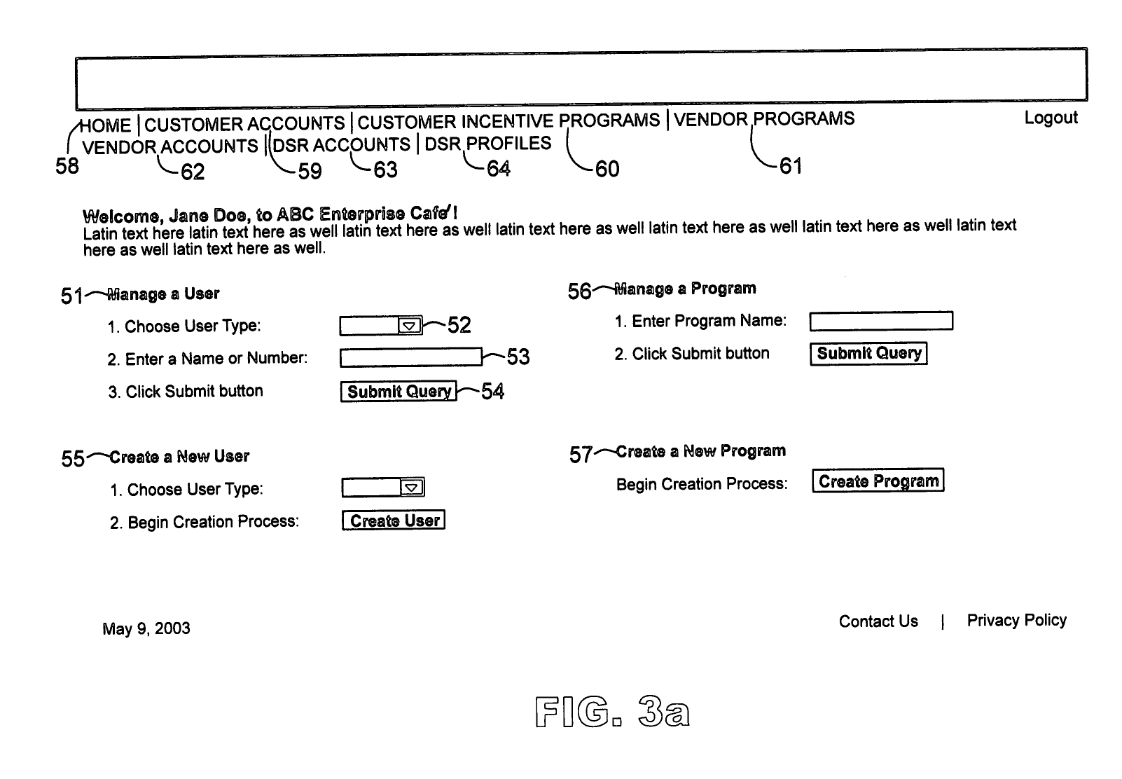

Referring to FIGS. 2a-2f, a series of pages, representing the customer interface, are shown. Referring particularly to FIG. 2a, the customer home page is shown. Generally, customers will reach the sign-in page FIG. 1 using a specific independent URL assigned to the participating Distributor by the Company. A link to this unique URL will be placed on the participating distributor's web site. By clicking on this link the user will open a new browser window and be taken to the designated URL residing within the Company's web application. The URL and application will not normally reside within the URL or domain of the Distributor.

As indicated above, customers will enter the application from a secure sign-in page FIG. 1 using a Customer Number or e-mail 10 and password 11 (both assigned by the Distributor). The system will recognize the Customer's sign-in and allow access to the appropriate areas of the application as assigned by the Distributor Administrator. First time users will need to obtain their password 11 from the associated Distributor Administrator. Customers not having email or web access will be set-up directly by the participating distributor just as if they were to use the web site. When setting up such a customer the distributor administrator will designate within the profile that the customer is to receive monthly printed statements.

Some of the displayed/selectable options (FIGS. 2a-2f) available to the customers include, but are not limited to; viewing account activity; viewing and applying for available programs (including details and terms); checking the status of the programs; redeeming accrued points.

Referring again to FIG. 2a, the customer homepage is the starting point from which he may choose from a series of options. Generally, the top of each page may include a banner 21, that could be utilized for various functions, such as, for example, source identification or advertisements. Just below the aforementioned banner 21, a series of operator selectable alternatives are displayed. By selecting the HOME option 22, the operator will access the customer home page FIG. 2a. The HOME page may display information pertaining to New programs 29, Account Summary 30, or other information 31 and 32. The Account Summary 30 shall provide the customer a summary of activity including, but not limited to, Statement Date, Starting Balance, Points Accrued, Withdrawals/Deductions, Available Balance, and Ending Balance.

Referring now to FIG. 2b, the MY Account page is shown. As with the previous page, a banner may appear at the top of the page. Additionally, an array of selectable options are located below the banner. Furthermore, this page may include a welcome statement 32 and account summary 30. This page provides additional detailed activity as well as program information tables 33. The aforementioned detailed tables may include information such as, “Distributor Item Code”, “Product Description”, “Brand Name”, “Manufacturer Code”, “Pak”, “Date Dlvd.”, “Cases Dlvd.”, “Net Wgt. Dlvd.”, “Pts. Per Unit”, and “Pts. Earned.” At the operator's preference, these tables can be viewed from either a manufacturing view 34 (as illustrated in FIG. 2b), Program view 35, or order view 36. While the aforementioned views are displayed as selectable options, additional view options are contemplated. Furthermore, the program provides the operator the option of printing or saving tables. The tables may be printed by selecting the print option 37, or saved by selecting the save option 38.

Referring now to FIG. 2c, the Earn Points page is shown. The Earn Points page is selectable from any of the operator accessible pages by selecting the Earn Points option 24 below the banner 21. The Earn Points page (FIG. 2c) may display a list of available programs that are selectable by the operator. The list may include categories such as, Manufacturer 39, Description 40, Status 41, and Run Dates 42. Additionally, the page may provide the user with a phone number, or a link to an e-mail address 43, enabling the operator access to customer assistance

Referring to FIG. 2d, the Redeem Points page is shown. Generally, this page provides the customers/users a means to redeem a portion or all of the points accumulated through program purchases. The first selectable option allows the operator to choose “How would you like to redeem, your points?” 44. The operator may choose between a “check from ______ foods”, or “credit against account.” While these two options are displayed in FIG. 2d, other options are contemplated. An additional selectable option allows the operator to choose “how many points would you like to redeem?” 45. The interface allows the operator to either redeem the entire balance, or another amount. The operator's balance may be displayed adjacent to the “Entire Balance” option. A space is provided adjacent to the “Another Amount” option, allowing the operator to enter/input a specific amount. Upon completion of the aforementioned selections, the operator can select/click the “Submit Query” button. Additionally, the page includes an Account Summary section and a “Redemption Terms” button 47 enabling the operator to access the redemption terms.

Referring now to FIG. 2e, the Customer Profile page is shown. The page is accessible by selecting the “View Profile” option 26 on the aforementioned customer pages.

The customer accessible pages further comprise a “Customer Support Page” FIG. 2f, that can provide answers to frequently asked questions, links, or live support.

When the operator chooses to exit the program, he may do so by selecting the “Logout” option, available on each page.

Generally, distributors are product or service providers to foodservice operations including, but not limited to, foodservice distributors, equipment and supply distributors, beverage distributors, paper and disposable product distributors, chemical distributors, produce distributors, meat distributors, poultry distributors, seafood distributors, service companies, etc. Individual users within distributor organizations may be either Distributor Administrators or Distributor Sales Representatives (DSR). Distributor Administrators are those individuals assigned or empowered by the distributor or service provider with decision-making authority pertaining to the application described herein. Examples of these users may include senior management, corporate product category managers, sales managers, buyers, marketing managers, major account managers, etc. Distributor Sales Representatives (DSR) are those individuals within the distributor sales organization charged with management and/or execution of some portion of the sales process and interaction with the customer in the course of doing business. Examples of these users include: sales representatives, sales managers, major account managers, chain account managers, healthcare specialists, customer service representatives, inside sales representatives, etc.

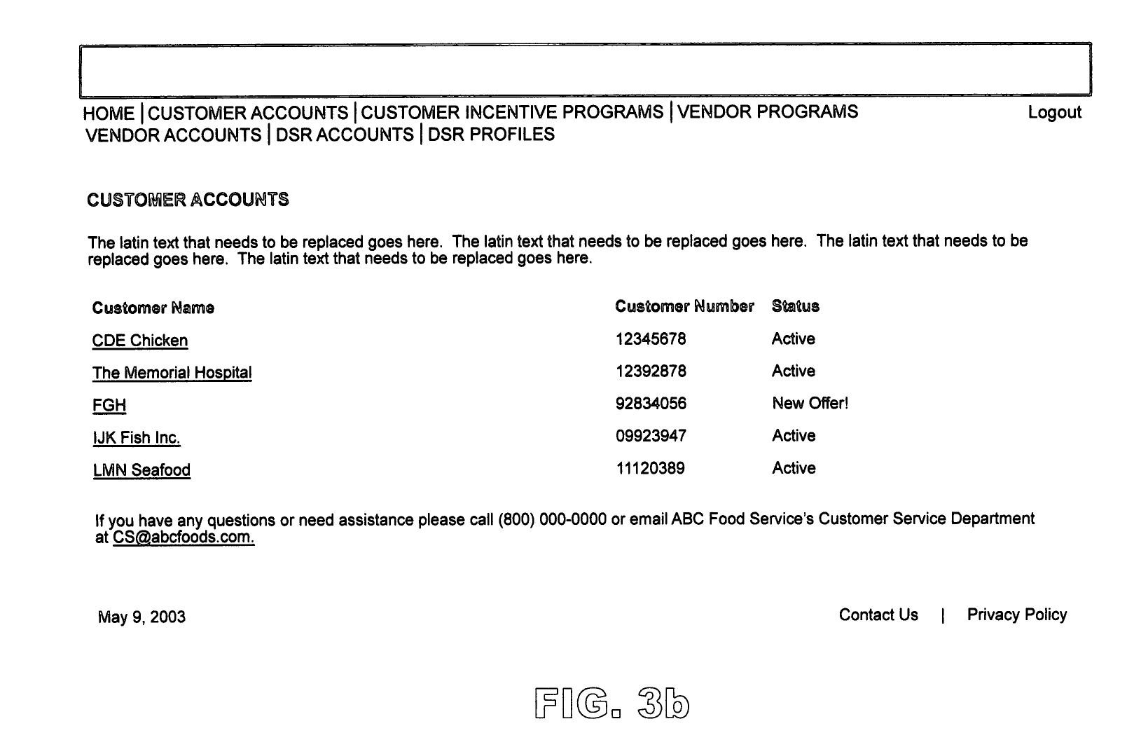

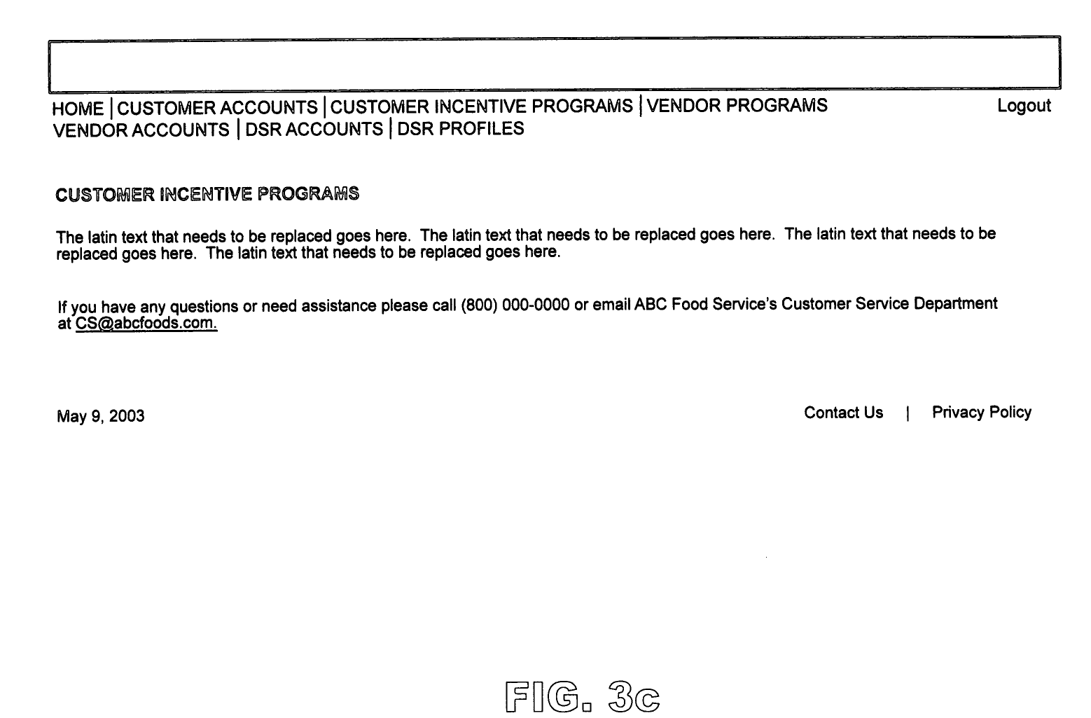

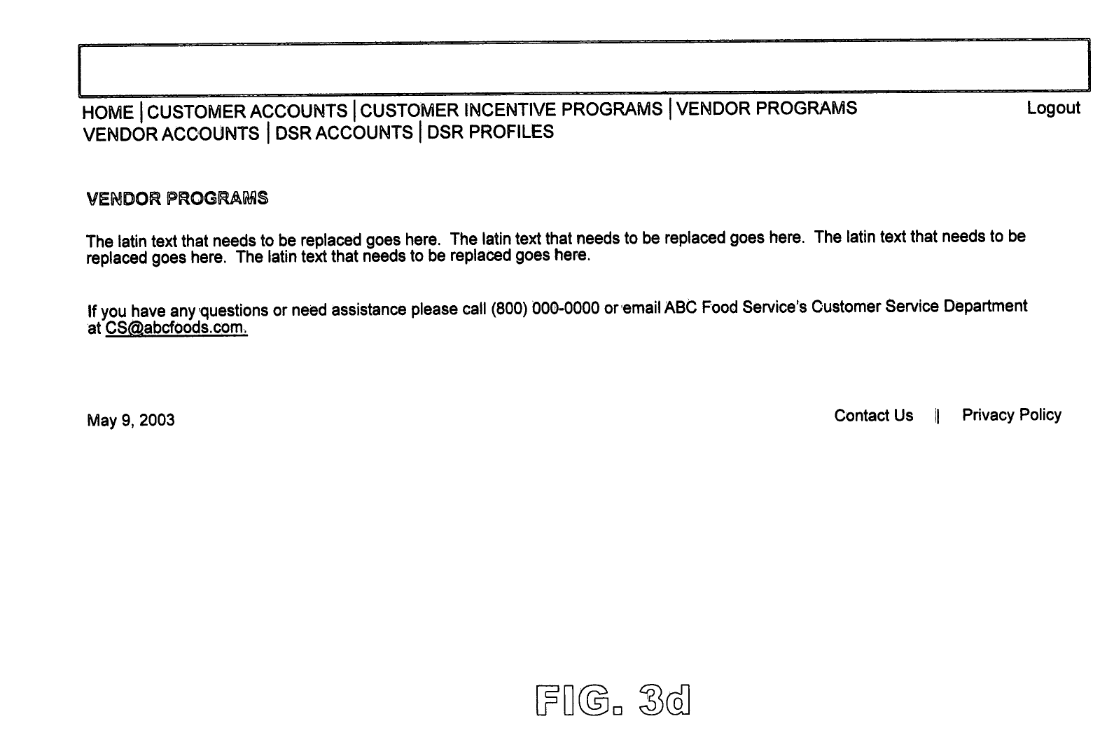

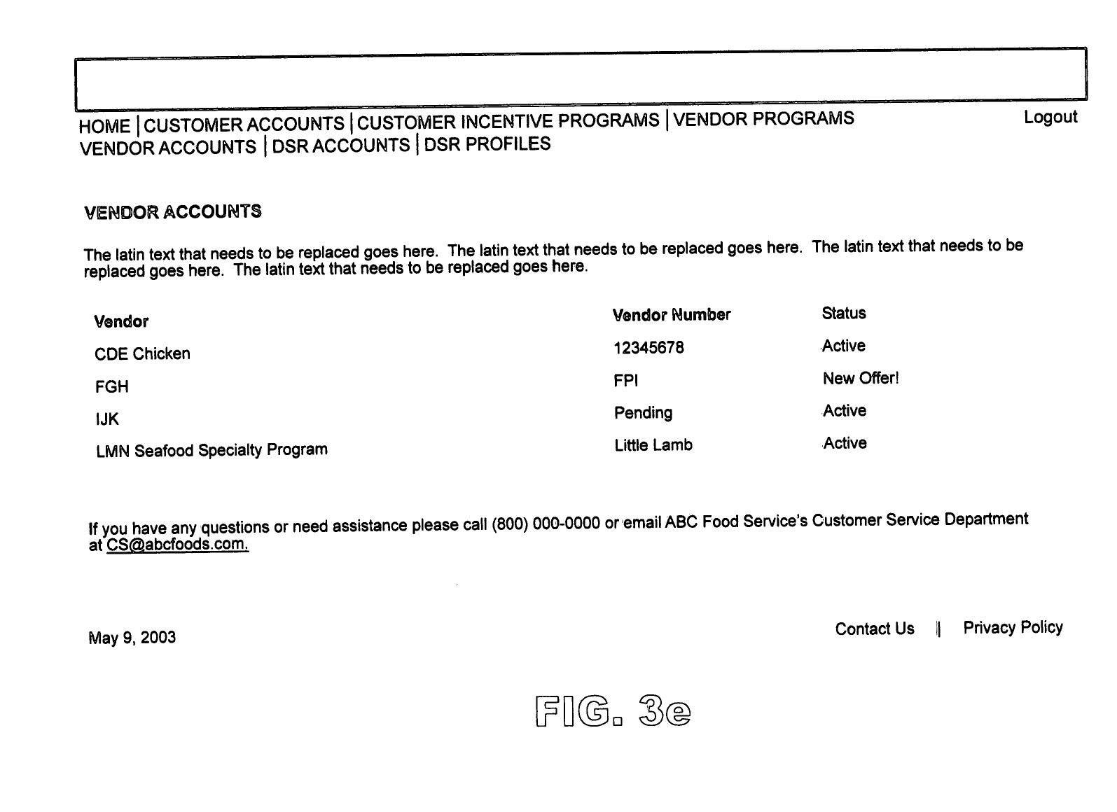

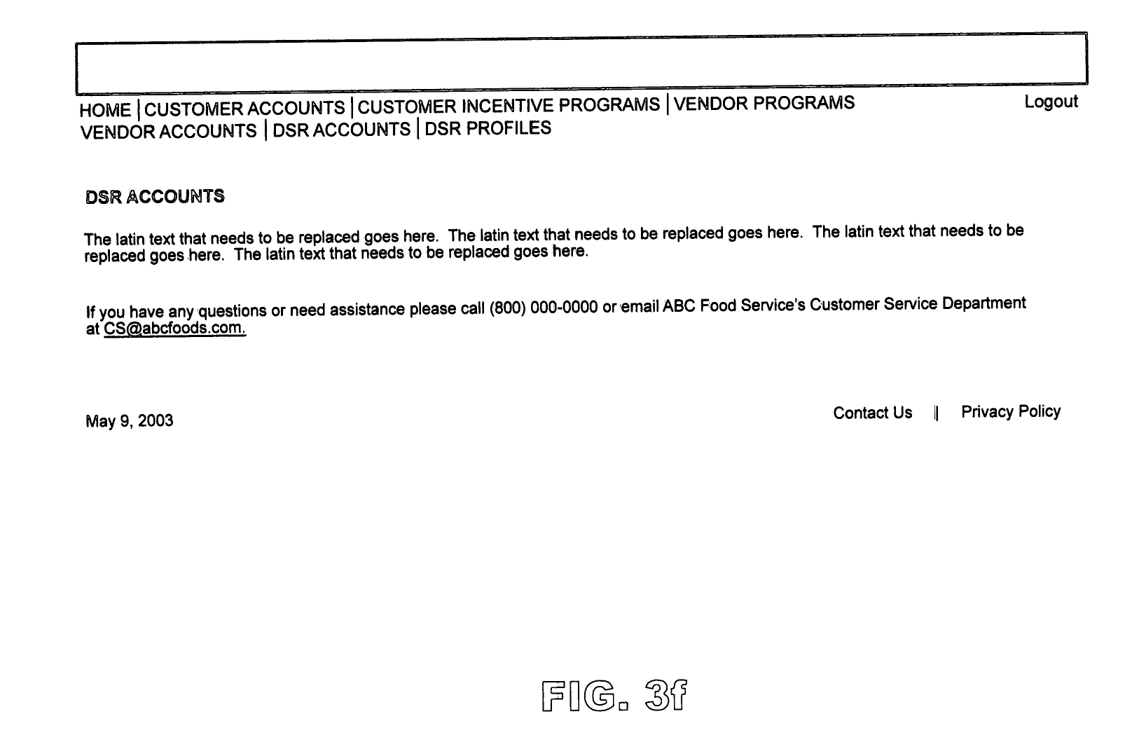

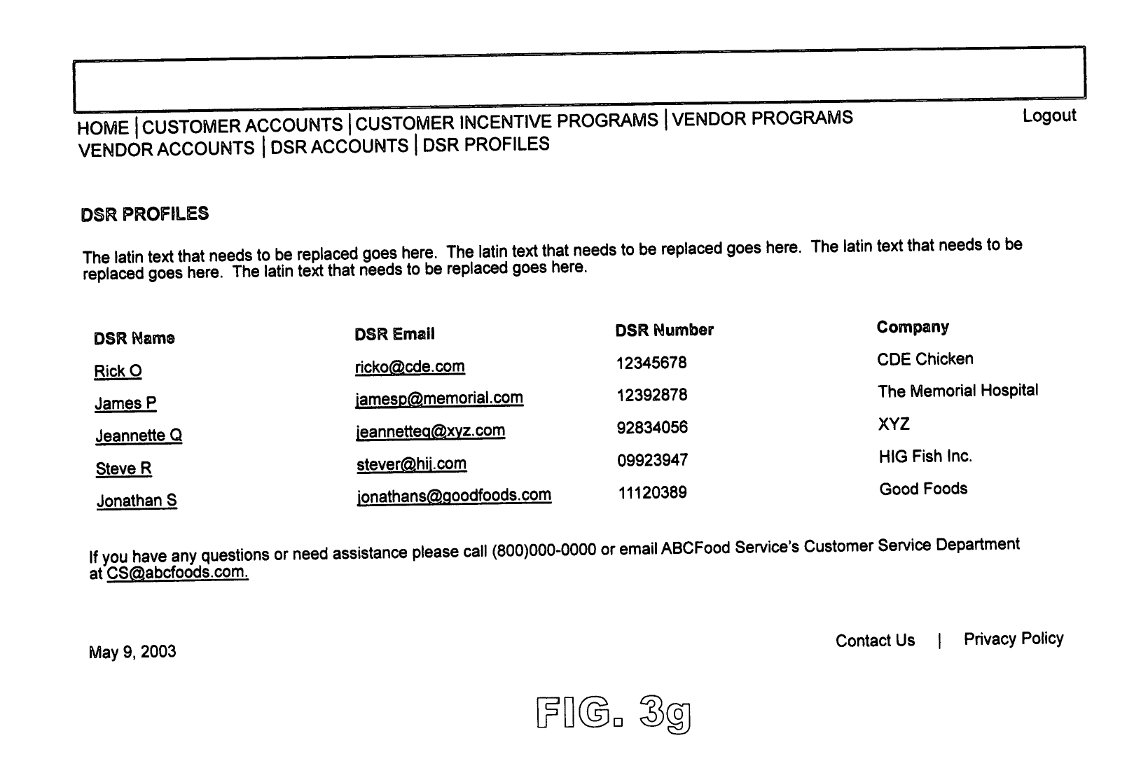

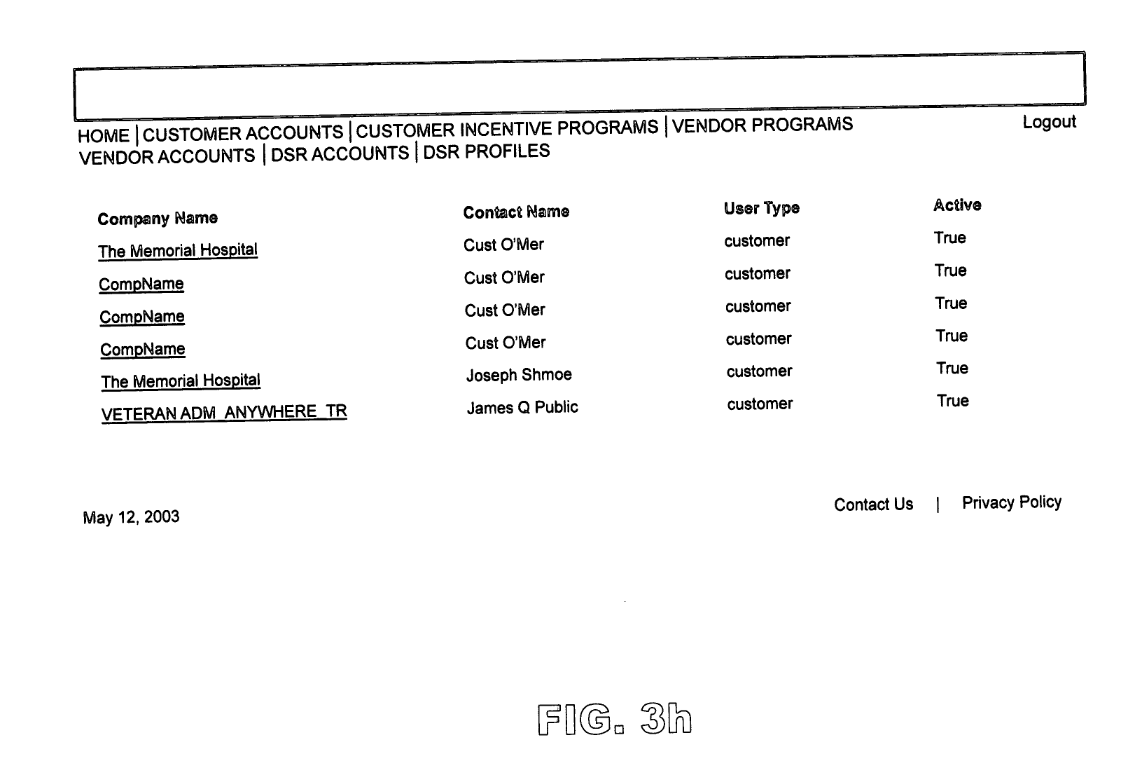

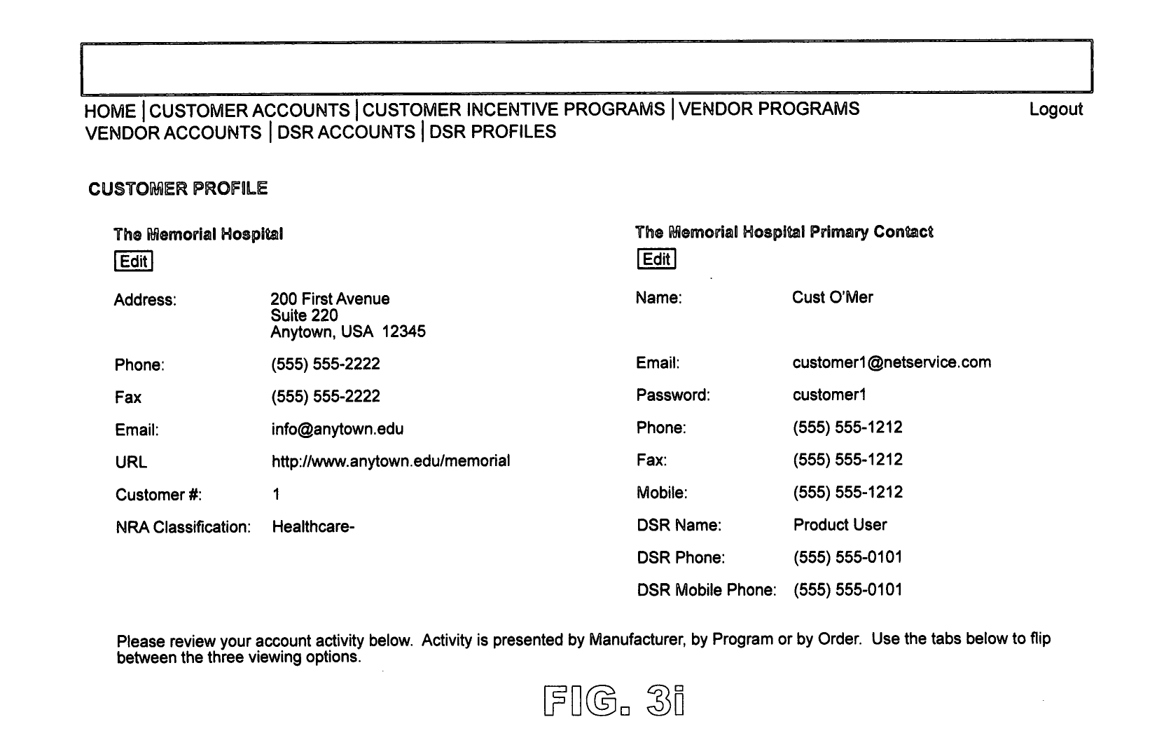

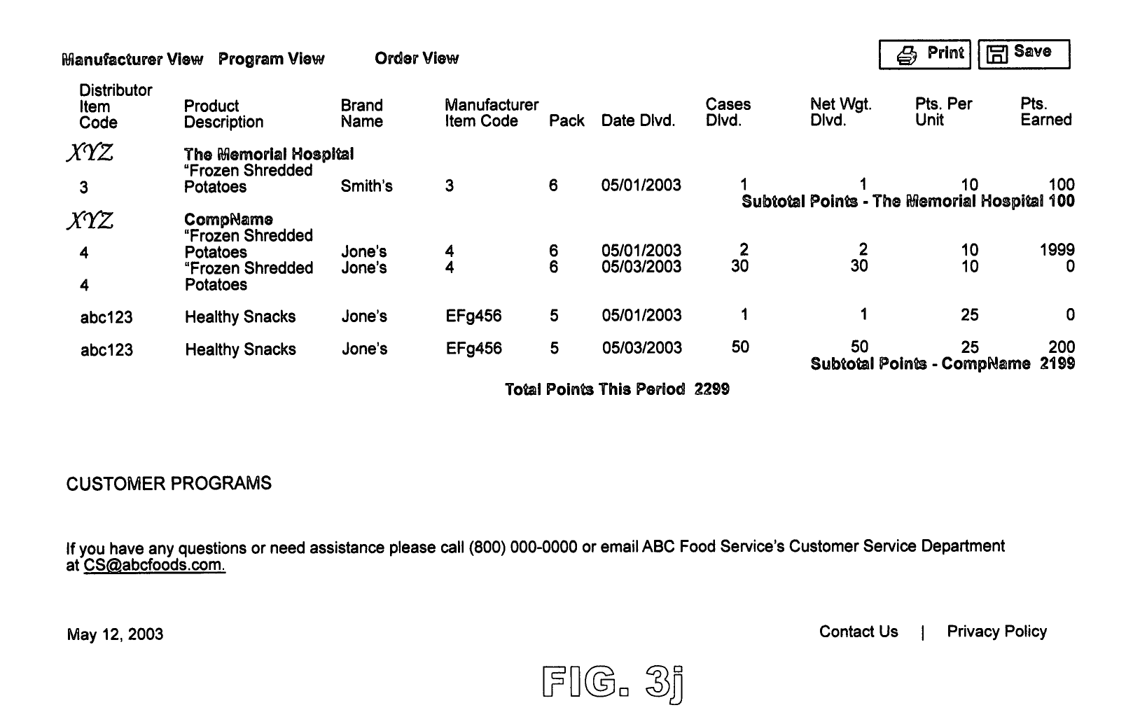

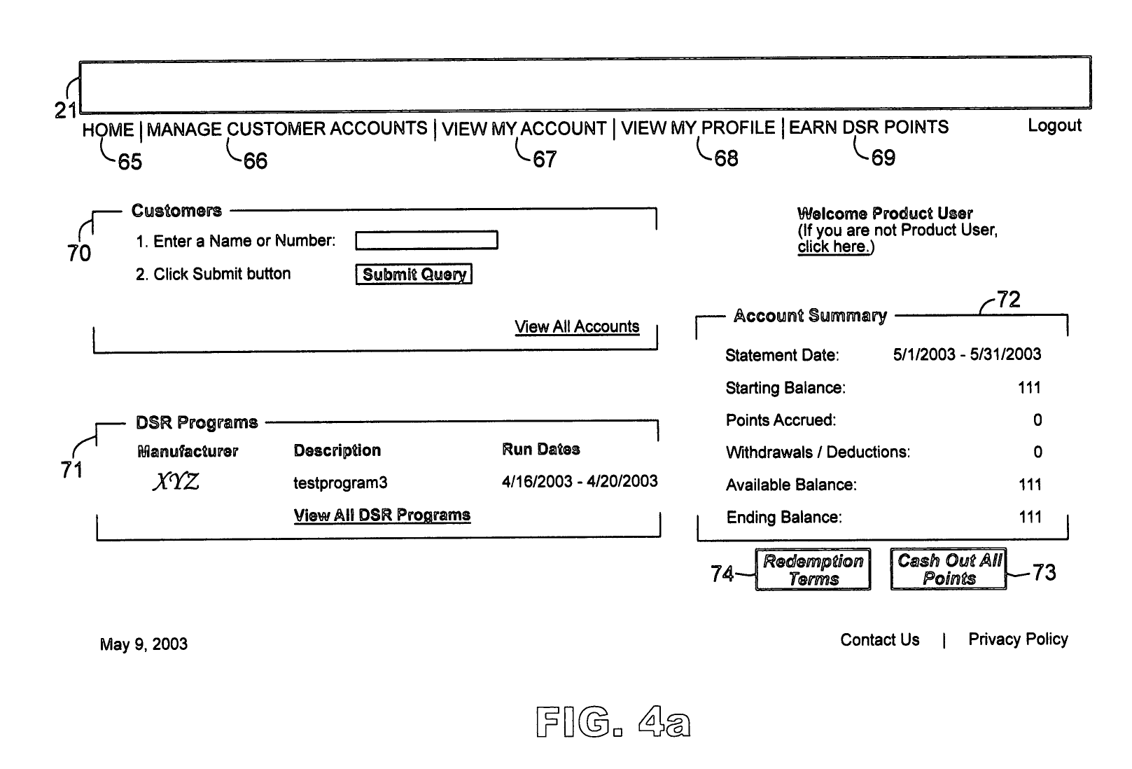

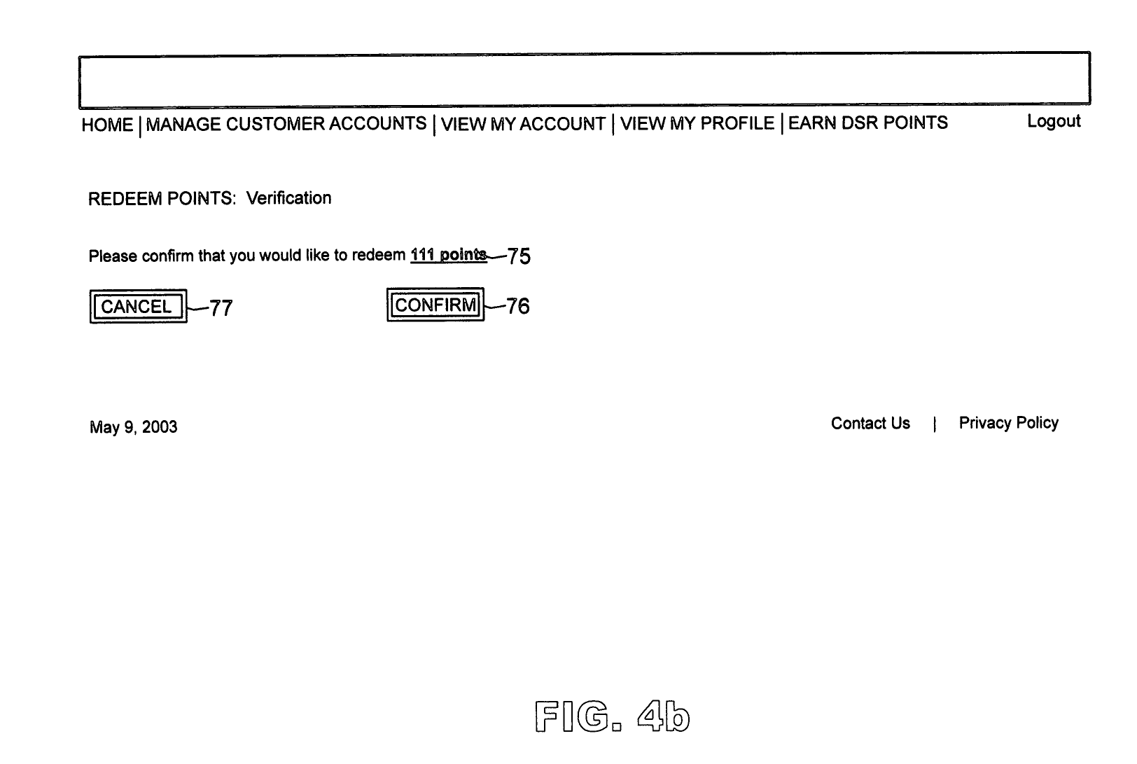

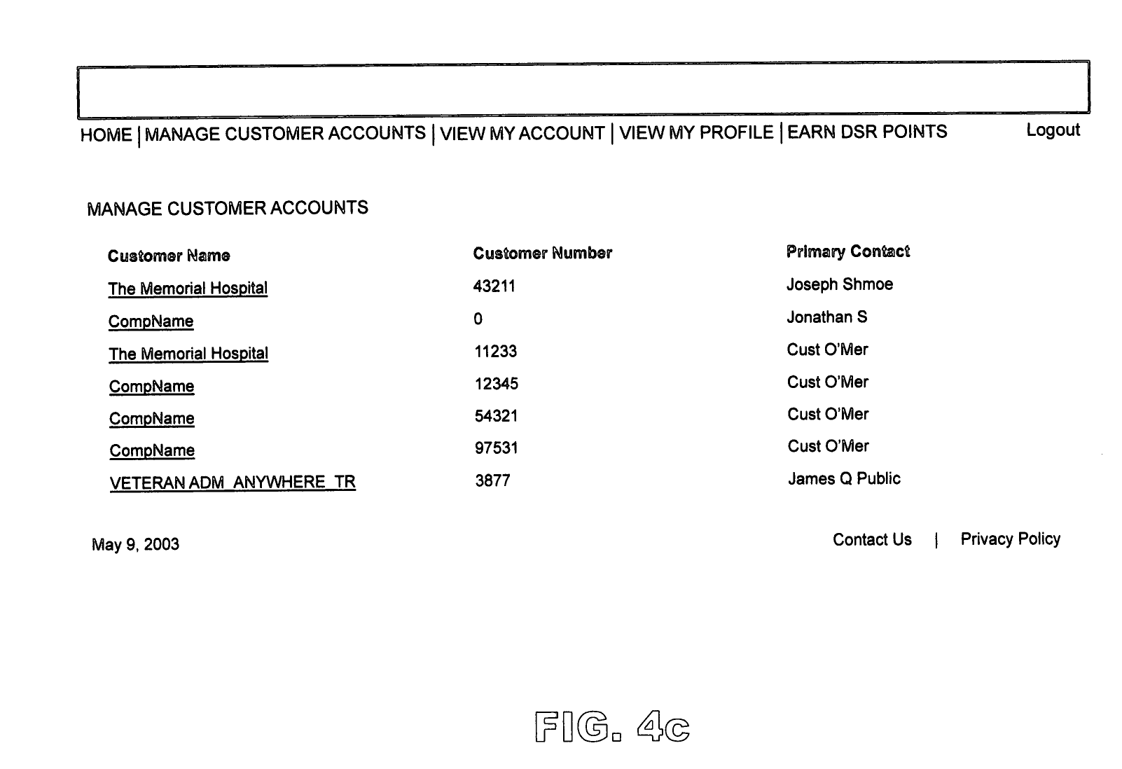

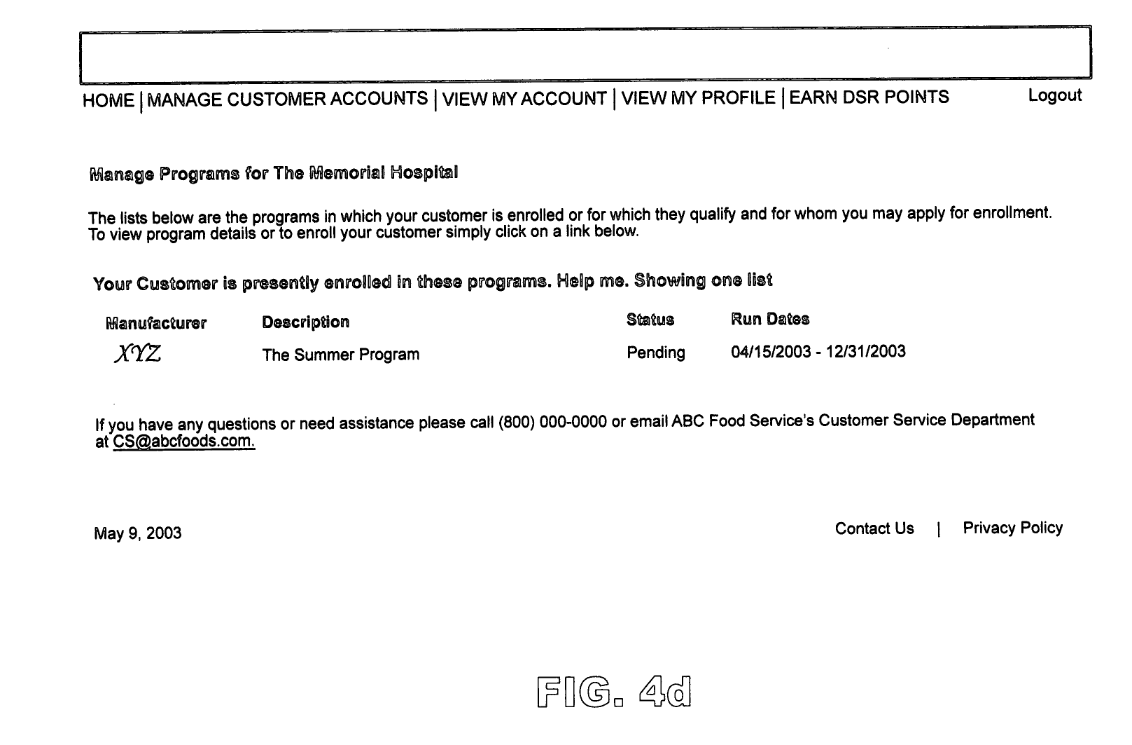

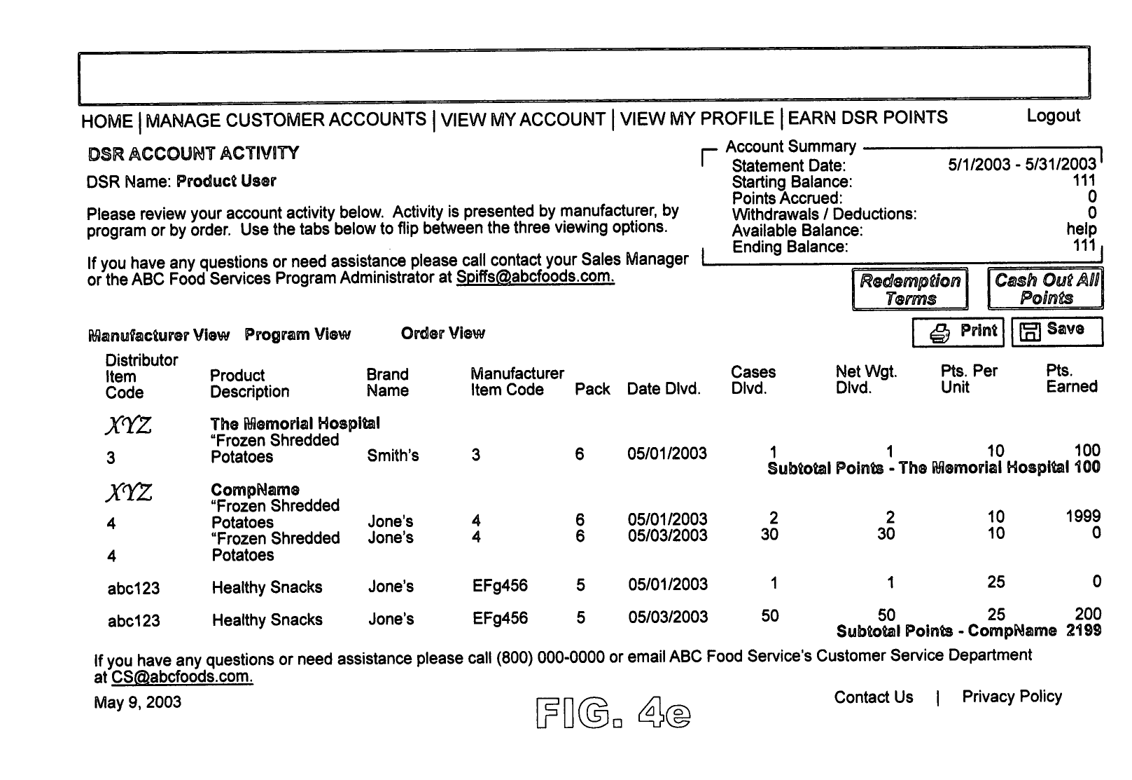

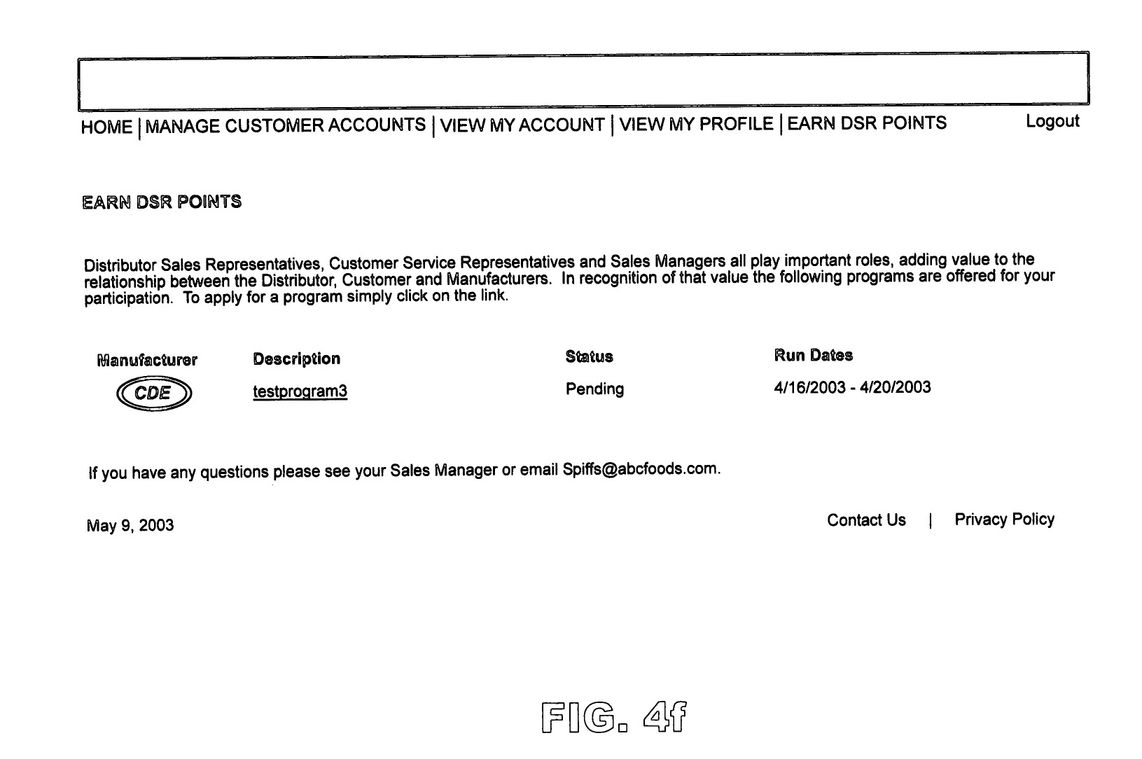

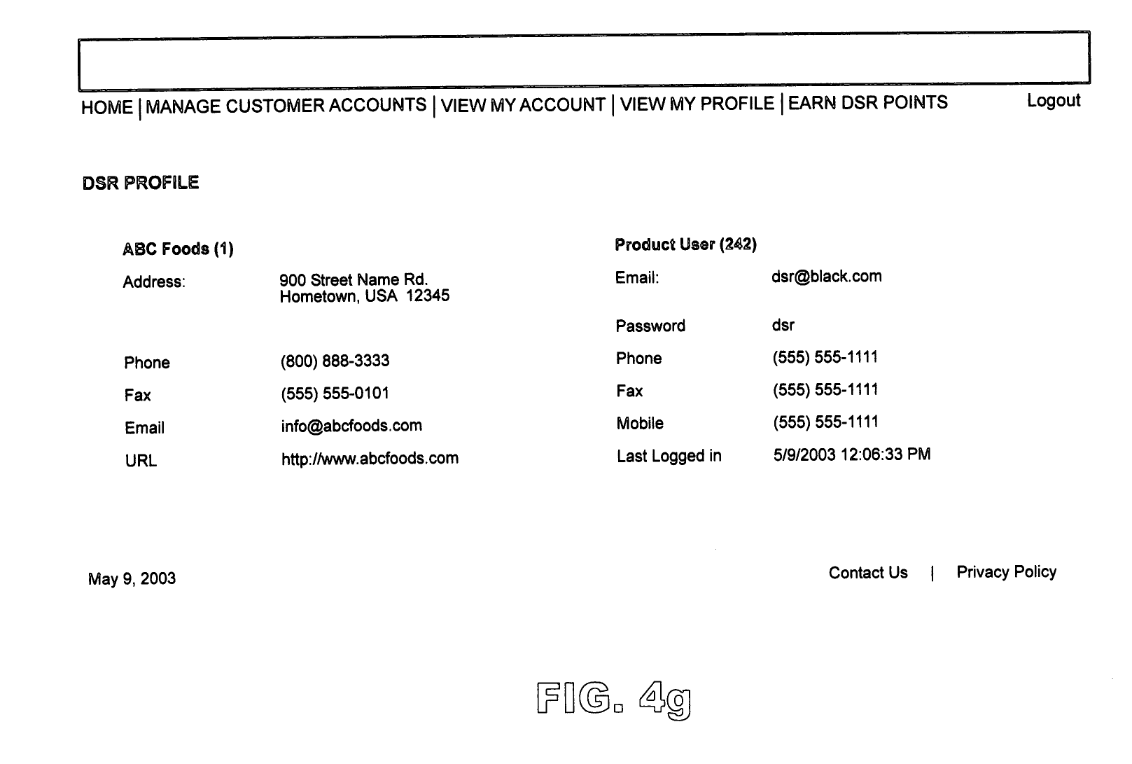

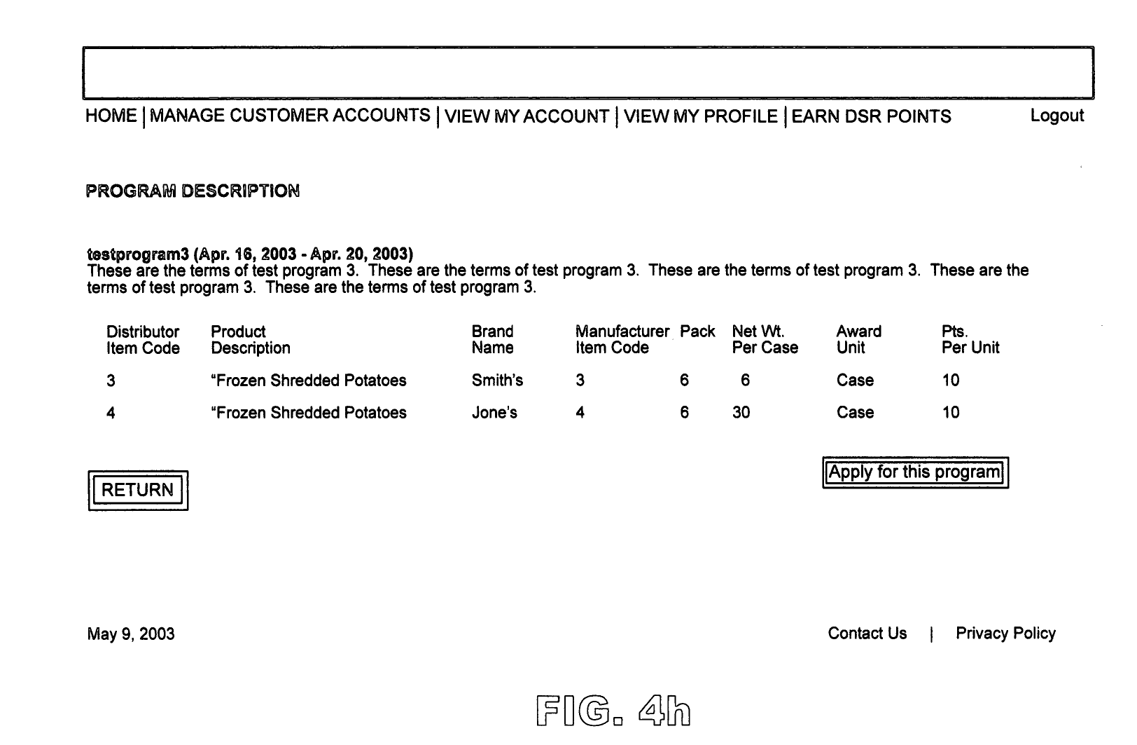

Referring now to FIG. 3a-3g and FIGS. 4a-4j respectively, the Distributor and DSR accessible interfaces are shown. Distributor Administrators and DSRs will reach the sign-in page FIG. 1 using a specific independent URL assigned to the participating distributor by the Company. A link to this unique URL will be placed on the participating distributor's web site. By selecting/clicking on this link the user will open a new browser window and be taken to the designated URL residing within the Company's web application. The URL and application will not normally reside within the URL or domain of the distributor. Distributors and DSRs will enter the application from a secure sign-in page using a Distributor Identifier (number) and password (both assigned by the Company). An alternative may provide for the Distributors or DSRs to sign-in using their email address 10, plus password 11. FIG. 1. The system will recognize the user's sign-in and allow access to the appropriate areas of the application as assigned by the Company. First time users will need to obtain their password from the associated Company administrator. Users not having email or web access will be set-up directly by the participating distributor just as if they were to use the website. When setting up such a customer the distributor administrator will designate within the profile that the customer is to receive monthly printed statements.

Referring again to FIG. 3a, the distributor administrator's home page is the starting point from which he may select from a number of options. Generally, the top of each page may include a banner 21, that may be used for source identification or advertising purposes. Just below the aforementioned banner 21, are a series of operator selectable options. The selectable options include, but are not limited to, “Home”, “Customer Accounts”, “Customer Incentive Programs”, “Vendor Programs”, “Vendor Accounts”, “DSR Accounts”, “DSR Profiles”.

In addition to the aforementioned options, various management options are also available on this page. One such selectable management option allows the operator to “Manage a User” 51. This option enables the operator to select a user type from a pull down menu 52. The selections on the pull down menu may include Customer, Multiunit, DSR, Distamin, Broker, and Manufacturer. Additionally, the operator can enter a name, or number in the available window 53. Once the desired information is entered, the operator accesses the user management section by clicking/selecting the “Submit Query” button 54. The user management section/page is displayed as FIG. 3h. Referring now to FIG. 3h, the page includes a plurality of columns, having titles such as, “Company Name”, “Contact Name”, “User Type”, and “Active”. From this page, the operator may select from a list of companies, and access a page wherein the customer profile can be edited/viewed, as illustrated in FIGS. 3i and 3j.

Referring again to FIG. 3a, additional management selectable options may include “Create a New User” 55, Manage a Program” 56, and “Create a New Program” 57. Aptly named, these options may allow the distributor administrator to create or add a new user to the system, manage incentive programs, or create new incentive programs.

Additionally, by clicking on the options labeled 59-64 of FIG. 3a, the distributor administrator is forwarded to the associated pages respectively labeled as the FIGS. 3b-3f. Selecting one of these options, grants the distributor administrator the ability to access and manage the desired accounts, programs, and/or profiles.

Referring to FIGS. 4a-4j, the DSR home page FIG. 4a is the starting point from which the DSR/user may access a series of options. Generally, the top of each page may include a banner 21, that may be used for source identification or advertising purposes. Just below the aforementioned banner 21, are a number of operator selectable options. The selectable options include, but are not limited to, “Home” 65, “Manage Customer Accounts” 66, “View My Account” 67, “View My Profile” 68, “Earn DSR Points” 69.

In addition to the aforementioned options, various management tools/options are accessible from this page. By accessing/selecting the Customer option 70, the operator may view either a specific customer account, or a list of all customer accounts. An additional management option allows the operator to view various DSR Programs 71. Furthermore, the DSR home page displays an “Account Summary” 72, further comprising a “Cash-out All Points” button 73, and “Redemption Term” button 74. Upon choosing to “Cash-out” option, the user accesses the page illustrated in FIG. 4b. The page provides a display indicating the number of points the operator may wish to redeem, as well as the options to confirm 76 or cancel 77.

Additionally, by selecting/clicking on the options labeled 66-69 of FIG. 4a, the DSR is forwarded to the associated pages. Selecting one of these options allows the distributor administrator to access and manage the desired accounts, programs, and/or profiles.

Referring now to FIG. 4c, the Manage Customer Accounts page is shown. The page consists of three columns, referred to as Customer Name, Customer Number, and Primary Contact. The operator may manage the customer account by selecting the desired customer from the Customer Name column. Upon selecting the name of the customer the operator will access a page similar to FIG. 4d. Referring now to FIG. 4d, the programs in which the customer is presently enrolled, are displayed. The page further provides Manufacturer Name, Description of Program, Status of Program, and Run Dates of the program.

The DSR may access information on his own account by selecting the “View My Account” option 67. Upon selection of this is option the DSR Account Activity page is displayed FIGS. 4f and 4g. The page allows the operator to view account activity from either a manufacturer view, a program view, or an order view. FIGS. 4f and 4g as illustrated, provide a manufacturer view. The columns include the Distributor Item Code, Product Description, brand Name, Manufacturer Item Code, Pack, Date Delivered, Cases Delivered, Net Weight Delivered, Points per Unit, and Points Earned. Generally, a subtotal of points will appear each customers respective section.

Referring now to FIG. 4h, the DSR profile page is shown. The DSR Profile page is accessible by selecting the View My Profile option 68, and may contain DSR information as displayed.

Referring now to FIG. 4i the Earn DSR Points page is shown. This page is accessible by selecting the Earn DSR Points option 69, and provides information of various incentive programs. The page may include a number of columns listing Manufacturer, Description, Status, and Run Dates. By selecting/clicking on a particular description, the operator accesses the Program Description page associated with the selected program FIG. 4j.

Referring to FIG. 4j, the Program Description page is shown. The Program Description page may comprise a listing of available programs, as well as their terms. The Program Description page further comprises an array of columns identifying Distributor Item Code, Product Description, Brand Name, Manufacturer Item Code, Pack, Net Wt. Per Case, Award Unit, and Points Per Unit. Additionally, a selectable button on the Program Description page, aptly named “Apply for this program” allows the operator to request participation in a program.

Generally, Vendors are defined as those business entities associated with the manufacturing, marketing, initial distribution and re-distribution of products to the distributors, as well as provision of products and/or services directly to the customers on behalf of the distributors. Vendors may either be manufactures and Brokers. Manufacturers are the companies, and their direct representatives, responsible for the actual manufacturing, processing, initial marketing and distribution of products and/or services to the distributors and their associated customers. Examples of these users include food manufacturers, food processors, agricultural product providers, chemical manufacturers, chemical service providers, equipment manufacturers, consolidated remarketing companies, etc. A single manufacturer may interact with multiple distributors, managing an individual account for each distributor location. Brokers are independently contracted third party representatives of the manufacturers, charged with marketing the products and services to the distributors and customers on behalf of that specific manufacturer. Brokers may have administration rights to manage programs for multiple manufactures at multiple distributor locations.

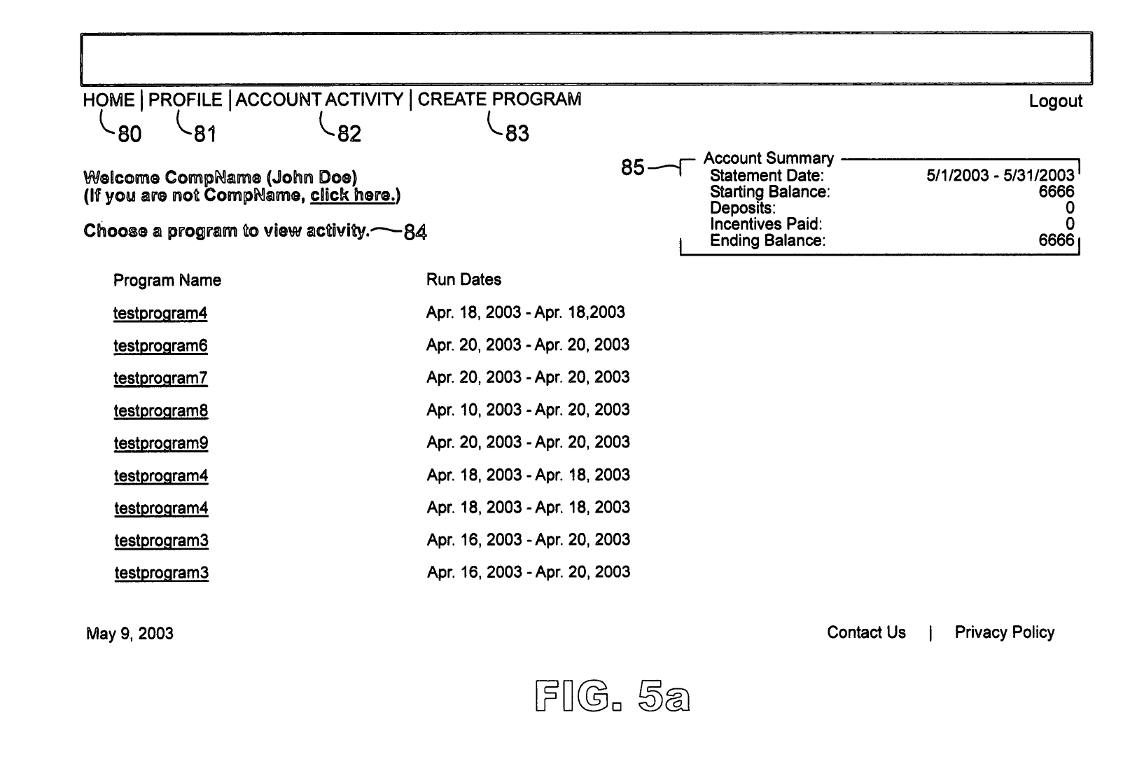

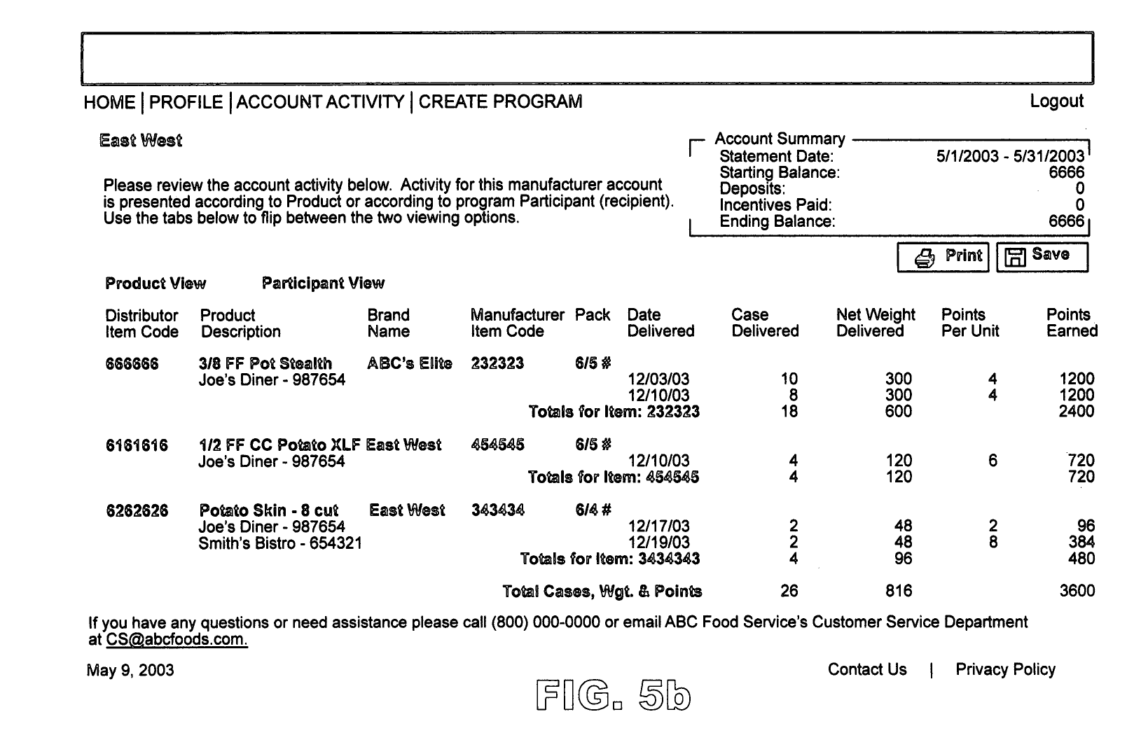

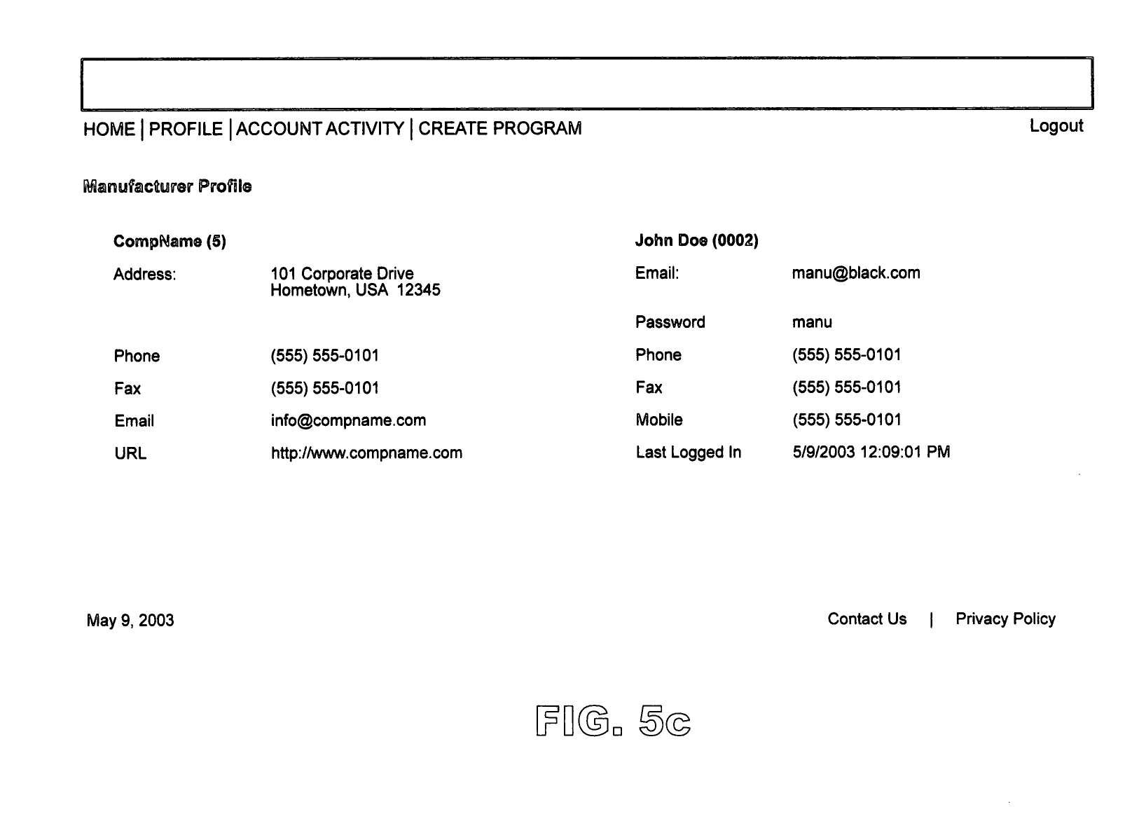

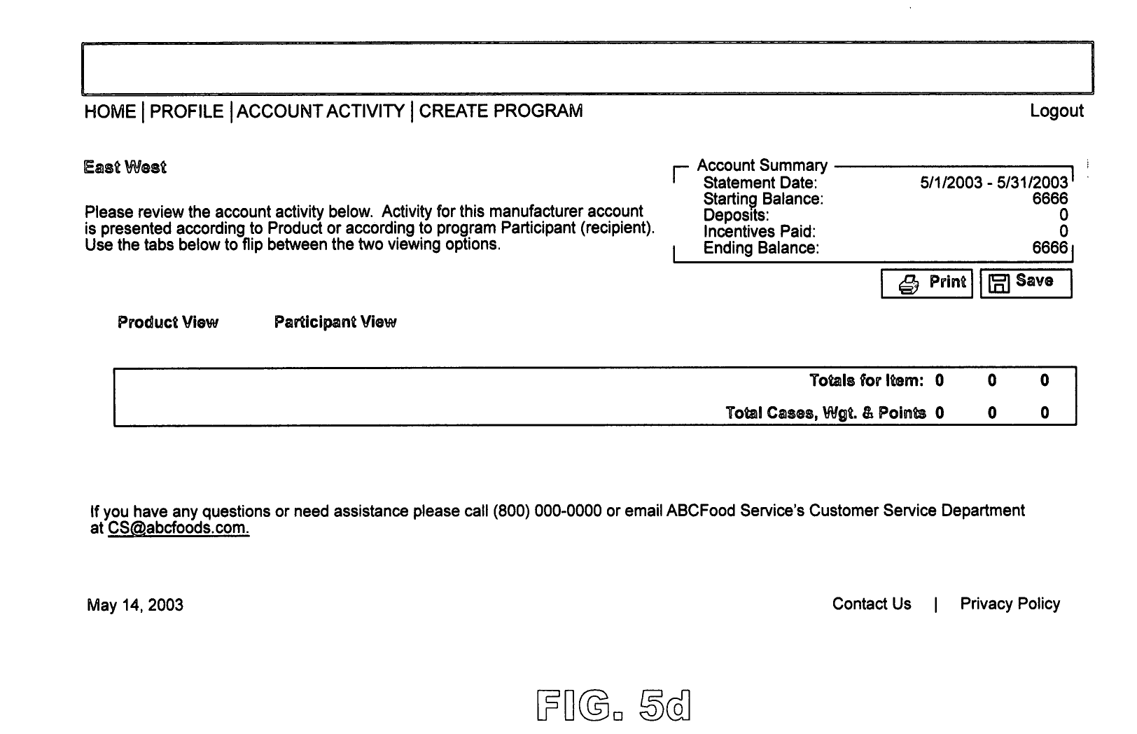

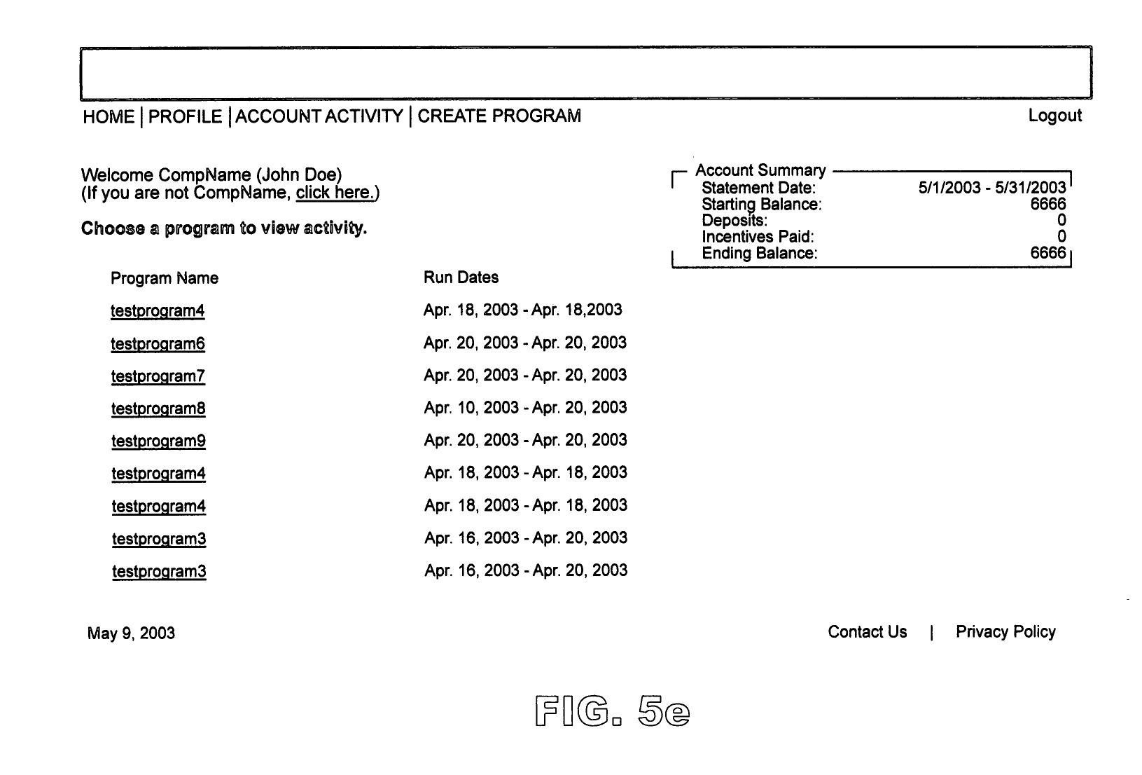

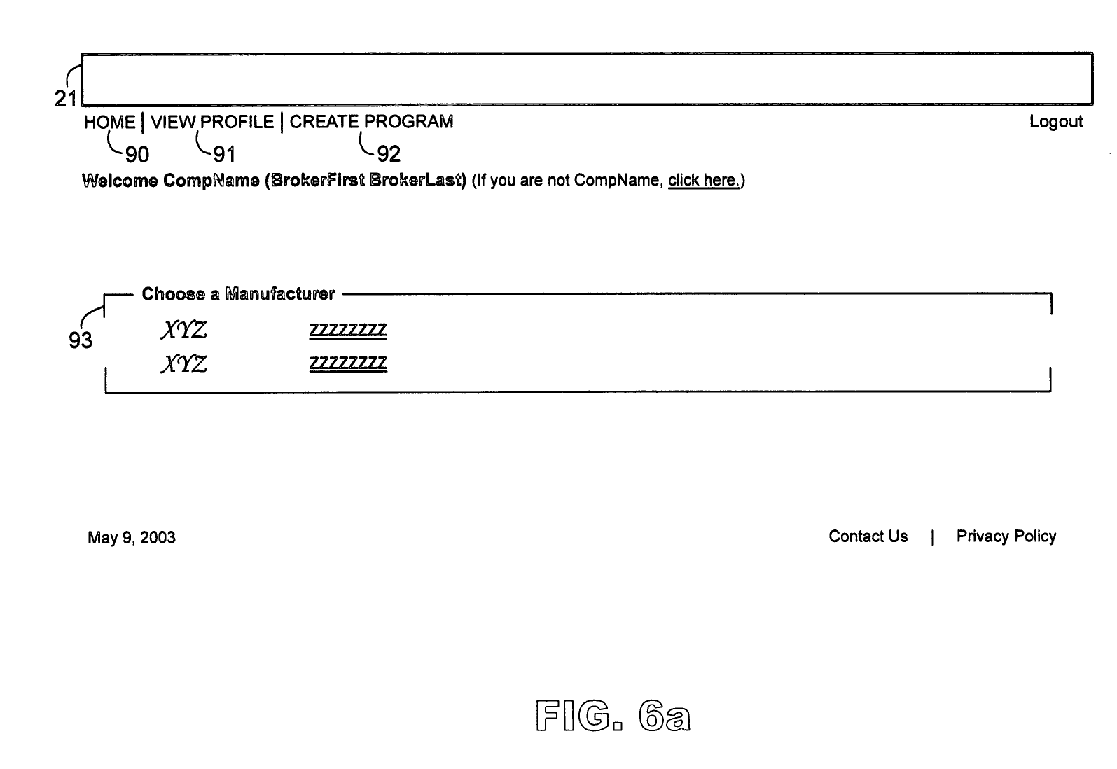

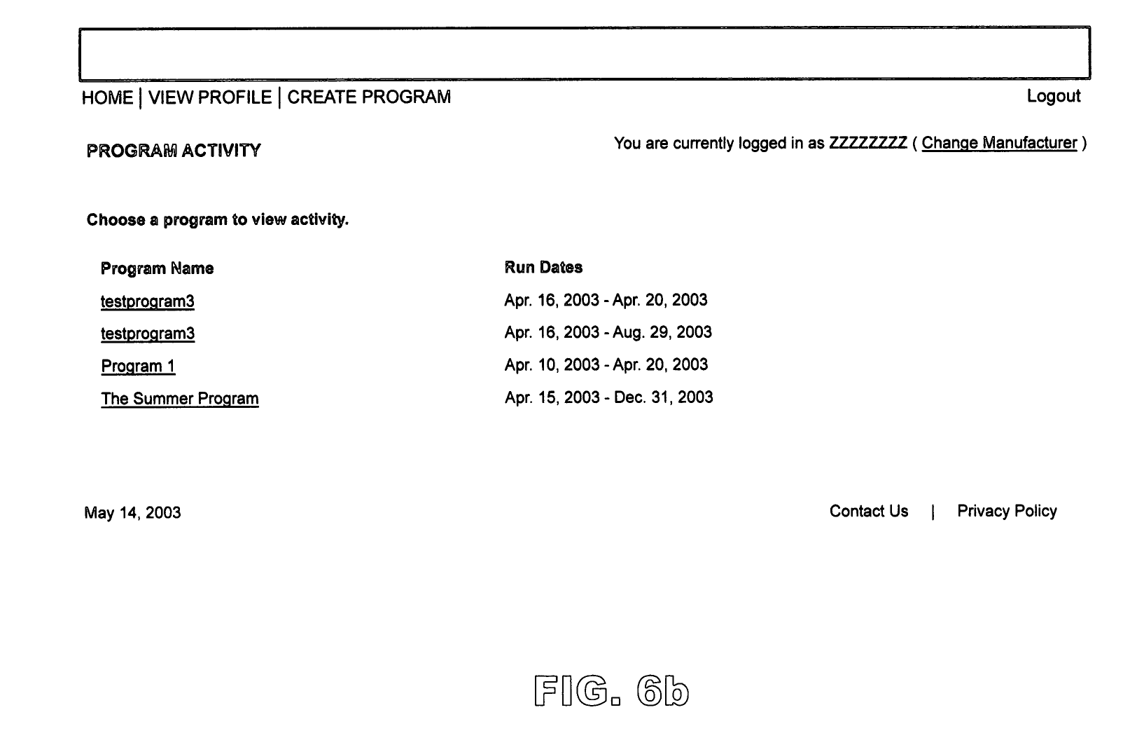

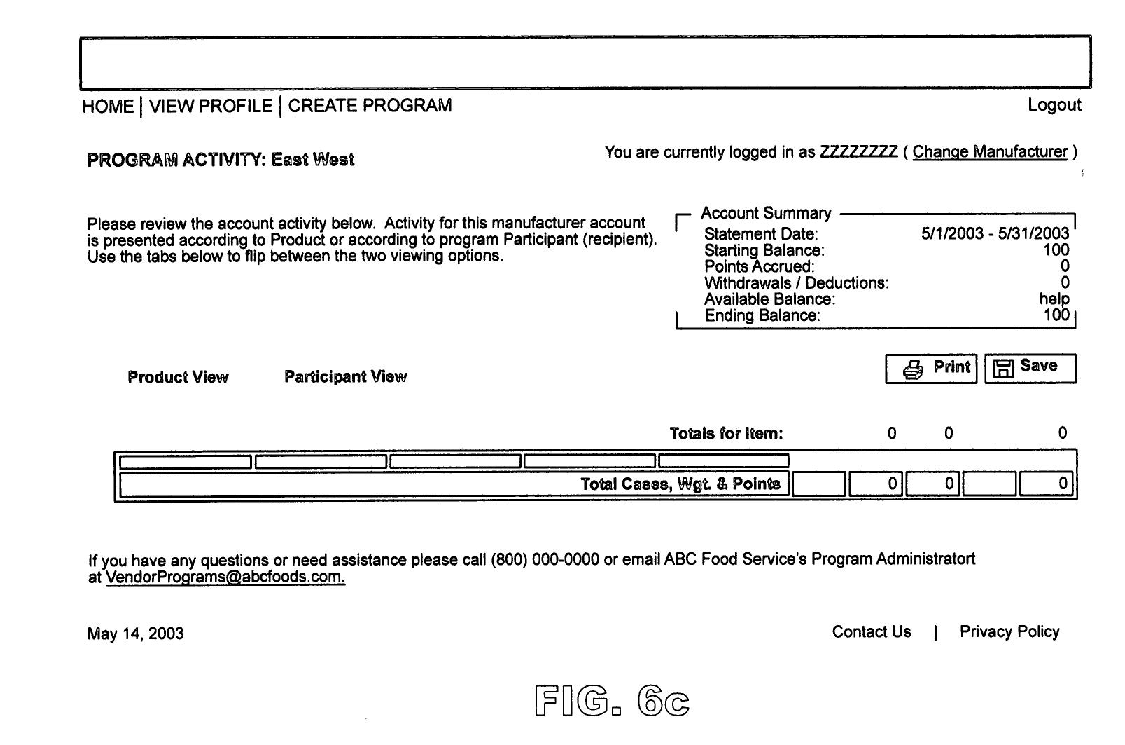

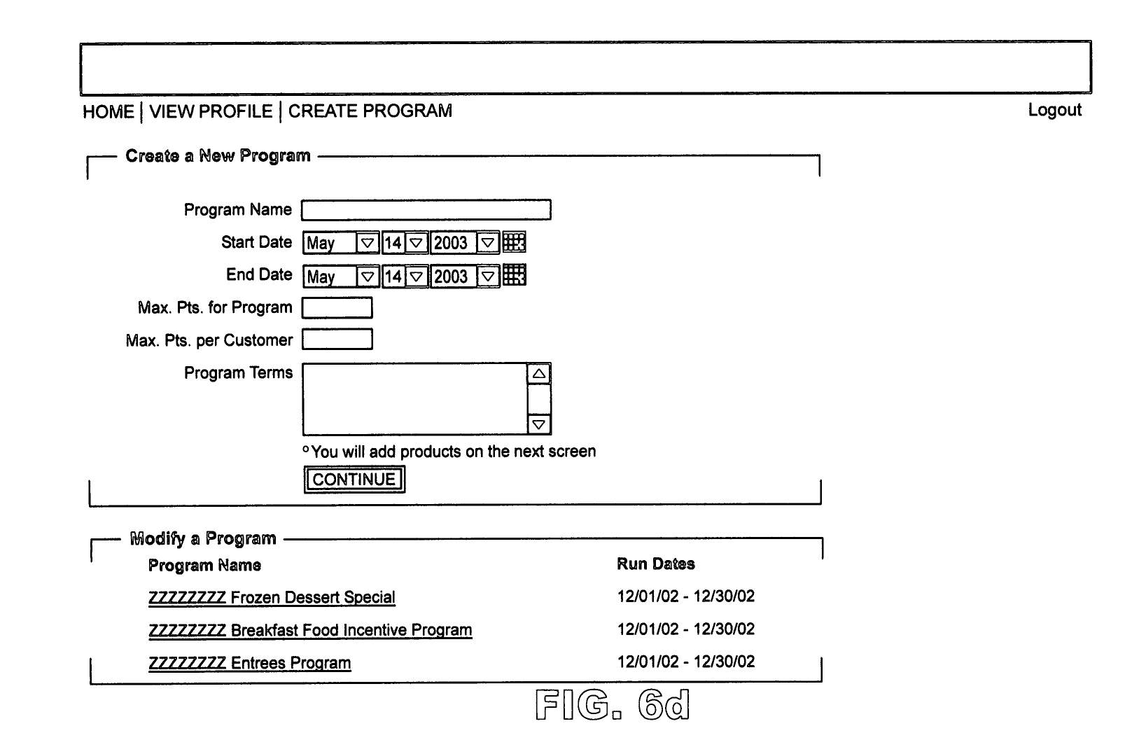

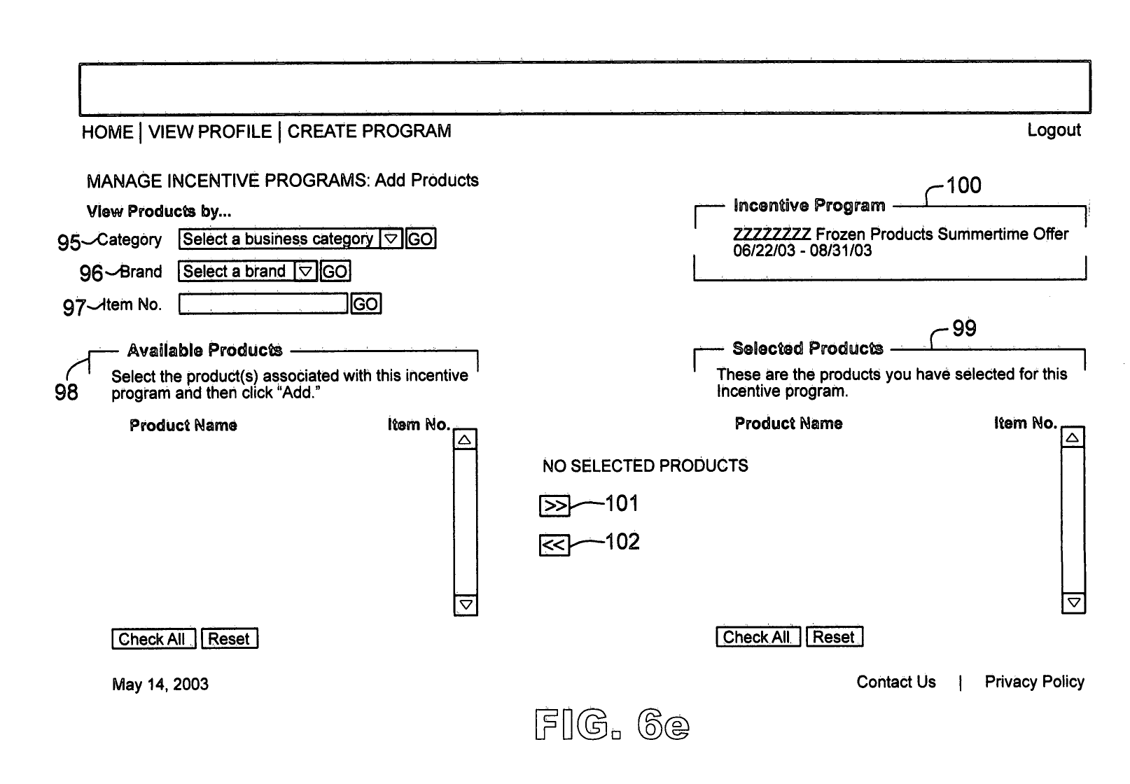

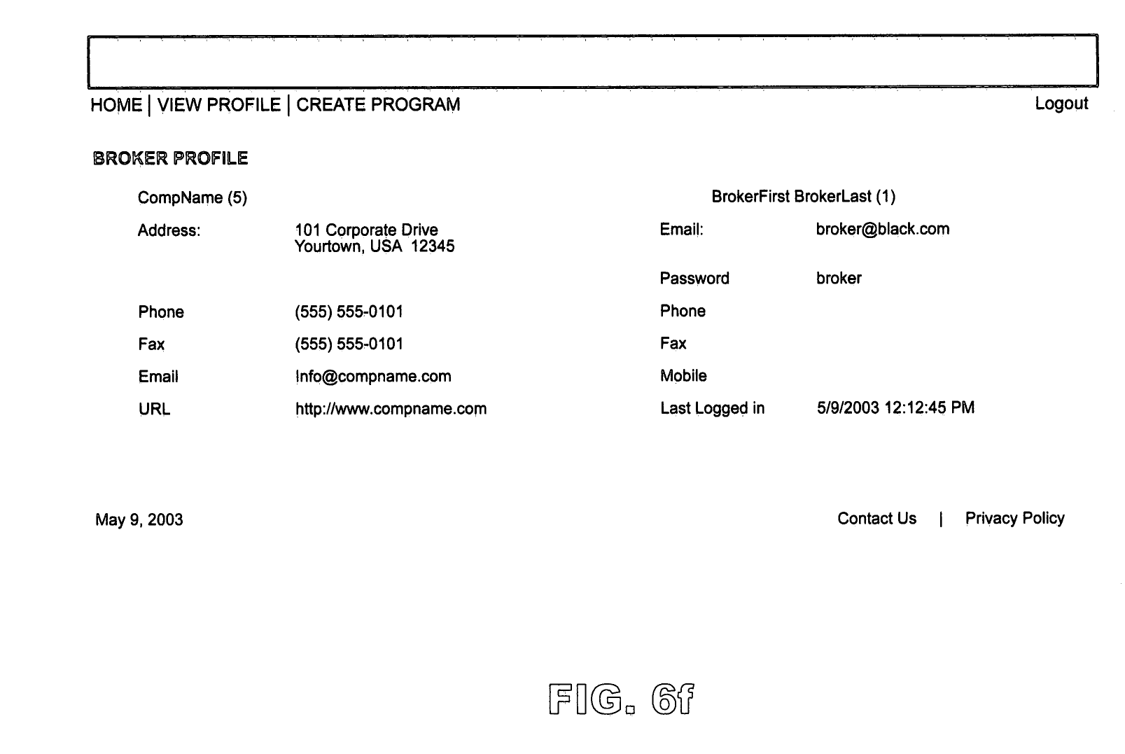

Referring now to FIGS. 5a-5e and FIGS. 6a-6e respectively, the Manufacturer and Broker interfaces are shown. Manufacturers and Brokers may reach the sign-in page FIG. 1 using a specific independent URL assigned to the participating distributor by the Company. A link to this unique URL will be placed on the participating distributor's web site. By clicking/selecting this link the user will open a new browser window and be taken to the designated URL residing within the Company's web application. The URL and application will not normally reside within the URL or domain of the distributor. Manufacturers and Brokers will enter the application from a secure sign-in page using a Identifier (number) and password (both assigned by the Company). An alternative may provide for the Manufacturers and Brokers to sign-in using their email address 10, plus password 11. FIG. 1. The system will recognize the user's sign-in and allow access to the appropriate areas of the application as assigned by the Company.

The present invention allows the vendor to view and select products from a list of products stocked by a participating distributor, wherein said product list is defined and controlled by the distributor. Furthermore, this interface will permit the manufacturer to view and administer their specific accounts associated with each distributor.

Referring now to FIG. 5a, the Manufacturer home page is the starting point from which he may access a series of options. Generally, the top of each page may include a banner 21, that may be used for source identification or advertising purposes. Just below the aforementioned banner 21, are a number of operator selectable options. The selectable options include, but are not limited to, “Home” 80, “Profile” 81, “Account Activity” 82, “and “Create Program” 83.

In addition to the aforementioned options, various management options are also accessible from this page. The “Choose a program to view activity” option 84, allows the operator/manufacturer to select from a list of available programs and monitor activity. Additionally, the Manufacturer home page displays an “Account Summary” 85, identifying “Statement Date”, “Starting Balance”, Deposits”, “Incentives Paid”, and “Ending Balance”.

Referring now to FIG. 5b, an Account Activity page is illustrated. The user is able to monitor all of the activity for a particular manufacturer via either a product view, or a participant/recipient view. The Account Activity page further comprises an array of columns identifying Distributor Item Code, Product Description, Brand Name, Manufacturer Item Code, Pack, Date Delivered, Case Delivered, Net Wt. Delivered, Points Per Unit, and Points Earned. Furthermore, a total is provided for each product or participant group below selected groups, particularly the Case Delivered, Net Wt. Delivered, Points Per Unit, and Points Earned groups. Additionally, as illustrated on the home page FIG. 5a, the Activity Page FIG. 5b also displays the account summary.

Referring now to FIG. 6a, the Broker home page is shown. Generally, the top of each page may include a banner 21, that may be used for source identification or advertising purposes. Just below the aforementioned banner 21, are a number of operator selectable options. The selectable options include, but are not limited to, “Home” 90, “View Profile” 91, and “Create Program” 92.

Additionally, various management options/tools are accessible from this page. One such option (Choose a Manufacturer) 93 allows the operator/manufacturer to select from a list of manufactures, and view programs offered by the specific manufactures. The accessible information may include Program Names and Run Dates (see FIG. 6b). By selecting a particular program from the Program Name column illustrated in FIG. 6b, the operator accesses Program Activity information as displayed in FIG. 6c. Referring again to FIG. 6b, the Program Activity information may include an Account Summary, and an option allowing the operator to choose between Product View or Participant View of program activity

Referring again to FIG. 6a, selecting the Create Program option 92 grants the user access to a series of tools, thereby enabling the user to create new incentive programs FIG. 6d. The Create a Program interface further provides the operator/broker a means for creating a program name, defining program start date and end date, defining the maximum points for the program, maximum points per customer, and program terms. Upon entry of the above information, the operator may begin to manage the incentive program via the Manage Incentive Program page FIG. 6e.

Referring now to FIG. 6e, the Manage Incentive Program page is shown. The operator may view selected products by either category 95, brand 96, or Item Number 97. Additionally the page displays a list of Available Products 98 associated with the incentive program and a list of Selected Products 99. Products can be moved between the two lists by highlighting the desired item, and clicking the appropriate add/remove button 101 102. Additionally the page includes an area identifying the selected Incentive Program 100, including the program name and run dates. Referring now to Fig. Of, the broker profile is shown. This profile contains various information on the broker as illustrated.

While this invention has been described as having a preferred design, the present invention can be further modified within the spirit and scope of this disclosure. This application is therefore intended to cover any variations, uses, or adaptations of the present invention using the general principles disclosed herein.

1. A method of providing a real time interactive marketing channel between foodservice customers, foodservice vendors, and foodservice distributors for monitoring incentive programs, comprising the steps of:
providing performance purchase incentives to food service customers from foodservice vendors via a real time application;
providing said foodservice vendors access to customer data and customer utilization of said incentive programs; and
monitoring utilization of said incentive programs.

2. The method of claim 1 wherein said foodservice distributors collect a fee from said foodservice vendors for providing said customer data and said incentive program utilization information.

3. The method of claim 1 wherein said real time application is administered by said foodservice distributors.

4. The method of claim 1 wherein said real time interactive marketing channel is internet based.

5. The method of claim 1 wherein said real time interactive marketing channel is intranet based.

6. A method of accessing an internet based marketing channel comprising the steps of:
submitting an identifier of a user;
accessing a data field based upon said user's authorization level;
choosing from a plurality of selectable options available to said user; and then
accessing a marketing channel.

7. The method of claim 6 wherein said user is a customer, and said plurality of selectable options comprise: return to home, viewing account activity, viewing and applying for available programs, checking the status of the programs, and redeeming accrued points.

8. The method of claim 6 wherein said user is a distributor administrator, and said plurality of selectable options comprise: home, customer accounts, customer incentive programs, vendor programs, vendor accounts, distributor sales representative accounts, and distributor sales representative profiles.

9. The method of claim 8 wherein said selectable options further comprise a plurality of management options including: managing a user, creating a new user, managing a program, and creating a new program.

10. The method of claim 6 wherein said user is a distributor sales representative, and said plurality of selectable options comprise: return to home, manage customer accounts, view my account, view my profile, and earn Distributor Sales Representative points.

11. The method of claim 10 wherein said selectable options further comprise a plurality of management options wherein said user may view a specific customer account, list all customer accounts, and view various Distributor Sales Representative programs.

12. The method of claim 10 wherein said Distributor Sales Representative home page displays an account summary further comprising a cash out all points option and a redemption term option.

13. The method of claim 12 wherein selecting the cash out all points option serves to provide the user with the number of points the operator may wish to redeem, and options to confirm or cancel the transaction.

14. The method of claim 6 wherein user is a vender.

15. The method of claim 14 wherein vender is a manufacturer, and said plurality of selectable options comprise: return to home, profile, account activity, and create program.

16. The method of claim 15 further comprising a management option wherein said manufacturer may choose a program to view its activity.

17. The method of claim 14 wherein said vender is a broker, and said plurality of selectable options further comprise at least one option from a group of options consisting of returning to home, viewing profile, or creating program.

18. The method of claim 17 further comprising a management option wherein the user may select from a list of manufacturers, and view programs offered by said manufacturers.

19. An Apparatus for providing a real time interactive marketing channel between foodservice customers, foodservice vendors, and foodservice distributors comprising:
a computer means having memory and networking means to link to other computer databases;
a means for accessing said databases wherein said databases include data about products, customers, volume, incentive programs, and supply value of incentives earned based on utilization of said incentives.
